(19) United States
(12) Patent Application Publication
(10) Pub. No.: US 2024/0330982 A1
(43) Pub. Date: Oct. 3, 2024

(54) DISPLAY OF PROMOTION TO PACKAGE RECIPIENTS LINKED TO WEBPAGES

(71) Applicant: FabFitFun, Inc., Los Angeles, CA (US)

(72) Inventor: Julian Van Erlach, Walnut, CA (US)

(21) Appl. No.: 18/738,451

(22) Filed: Jun. 10, 2024

Related U.S. Application Data
(63) Continuation-in-part of application No. 17/973,614, filed on Oct. 26, 2022.
Application No. 17/973,614 is a continuation-in-part of application No. 17/899,979, filed on Aug. 31, 2022.
Application No. 17/899,979 is a continuation of application No. 17/451,840, filed on Oct. 22, 2021, now Pat. No. 11,468,473.

(51) Int. Cl. G06Q 30/0251; G06K 1/12; G06K 19/07; G06Q 10/083; G06Q 10/0833; G06Q 10/087; G06Q 30/0201; G06Q 30/0241; G06Q 30/0273; G09F 3/00

(52) U.S. Cl. CPC G06Q 30/0255; G06K 1/121; G06K 19/0723; G06Q 10/0833; G06Q 10/0838; G06Q 30/0201; G06Q 30/0269; G06Q 30/0275; G09F 3/0297; G06Q 10/087; G06Q 30/0276

(57) ABSTRACT

A method, computer program product, and package tracking platform for displaying a promotion to package recipients linked to webpages. The package tracking platform receives a request from a promotion entity to display the promotion to package recipients having respective recipient profiles. The package tracking platform selects, or receives a selection of, package recipients based on: the recipient profile of each selected package recipient satisfying recipient criteria specified in the request; and each selected package recipient has ordered, from a shipper, a package of goods associated with an active order. The package tracking platform displays, on a package tracking webpage, the promotion to each selected package recipient who is linked to the package tracking webpage. The package tracking webpage has a look and feel of a webpage at a website of a package provider. The package tracking website is not owned or controlled by the package provider.

### CROSS REFERENCE TO RELATED APPLICATIONS

This application is a continuation in part application claiming priority to Ser. No. 17/973,614 filed Oct. 26, 2022, the contents of which are hereby incorporated by reference in its entirety, which is a continuation in part of, and claiming priority to, Ser. No. 17/899,979 filed Aug. 31, 2022 and issued Jul. 11, 2023 as U.S. Pat. No. 11,699,170, which is a continuation of, and claiming priority to, Ser. No. 17/451,840 filed Oct. 22, 2021 and issued Oct. 11, 2022 as U.S. Pat. No. 11,468,473.

### BACKGROUND

Embodiments of the present invention relate to displaying a promotion to package recipients who are ordering a good or returning the ordered good and who are linked to a package tracking webpage.

### SUMMARY

Embodiments of the present invention provide a method, computer program product, and computer system for displaying a promotion to package recipients linked to webpages.

A package tracking platform receives a request to display the promotion to package recipients selected from multiple package recipients having respective recipient profiles, wherein the request specifies recipient criteria to be satisfied.

The package tracking platform selects, or receives a selection of, package recipients from multiple package recipients. The package recipients are selected or were selected based on (i) the recipient profile of each selected package recipient satisfying the recipient criteria specified in the request and (ii) each selected package recipient having ordered a package of good from a shipper such that the package has the package status of a SHIP status of currently being shipped to the package recipient via a first freight carrier or a RETURN status of currently being returned from the package recipient to the shipper via a second freight carrier.

The package tracking platform displays, on a package tracking webpage of a package tracking website, the promotion to each selected package recipient who is linked to the package tracking webpage. The package tracking webpage has a look and feel of a webpage at a website of a package provider selected from the group consisting of the shipper and one freight carrier. The one freight carrier is the first freight carrier or the second freight carrier if the package currently has the SHIP status or the RETURN status, respectively.

The package tracking website is not owned or controlled by the package provider.

### BRIEF DESCRIPTION OF THE DRAWINGS

FIG. 1A illustrates a system for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated with the package for delivery or a demographic profile of a package recipient, in accordance with embodiments of the present invention.

FIG. 1B illustrates an exploded view of the data structure 250 of FIG. 1A, in accordance with embodiments of the present invention.

FIG. 2A illustrates an algorithm detailing a process flow enabled by the system of FIG. 1A for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated with the package for delivery or a demographic profile of a package recipient, in accordance with embodiments of the present invention.

FIG. 2B illustrates a first alternative algorithm detailing a process flow enabled by the system of FIG. 1A for improving software implemented promotional structure generation technology associated with and generating and deploying a physical or digital visible promotional structure associated with the package for delivery or a demographic profile of a package recipient, in accordance with embodiments of the present invention.

FIG. 2C illustrates a second alternative algorithm detailing a process flow enabled by the system of FIG. 1A for improving software implemented promotional structure generation technology associated with and generating and deploying a physical or digital visible promotional structure associated with the package for delivery or a demographic profile of a package recipient, in accordance with embodiments of the present invention.

FIG. 3 illustrates an internal structural view of the software/hardware of FIG. 1, in accordance with embodiments of the present invention.

FIG. 4 illustrates a recipient order content-based demographic profiling and promotion system, in accordance with embodiments of the present invention.

FIG. 5 illustrates a package recipient promotion generation system, in accordance with embodiments of the present invention.

FIG. 6 illustrates cross-referencing system, in accordance with embodiments of the present invention.

FIG. 7 illustrates a computer system used by the system of FIG. 1A for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated with the package for delivery or a demographic profile of a package recipient, in accordance with embodiments of the present invention.

FIG. 8 illustrates a system, in accordance with embodiments of the present invention.

FIG. 9 illustrates a partial view of a recipient profile in a recipient profiles database in the system of FIG. 8, in accordance with embodiments of the present invention.

FIG. 10 is a flow chart of a first embodiment of a method of displaying a promotion to package recipients linked to webpages, in accordance with embodiments of the present invention.

FIG. 11 is a flow chart of a process that implements a step in FIG. 10 of determining whether to display the promotion to the package recipient, in accordance with embodiments of the present invention.

FIG. 12 is a flow chart of a process that implements a step in FIG. 10 of displaying the promotion to a package recipient at package tracking webpage if the package recipient is linked to the package tracking webpage, in accordance with embodiments of the present invention.

FIG. 13 is a flow chart of a second embodiment of a method of displaying a promotion to package recipients linked to webpages, in accordance with embodiments of the present invention.

FIG. 14 is a flow chart of a process that implements a step in FIG. 13 of selecting package recipients, in accordance with embodiments of the present invention.

### DETAILED DESCRIPTION

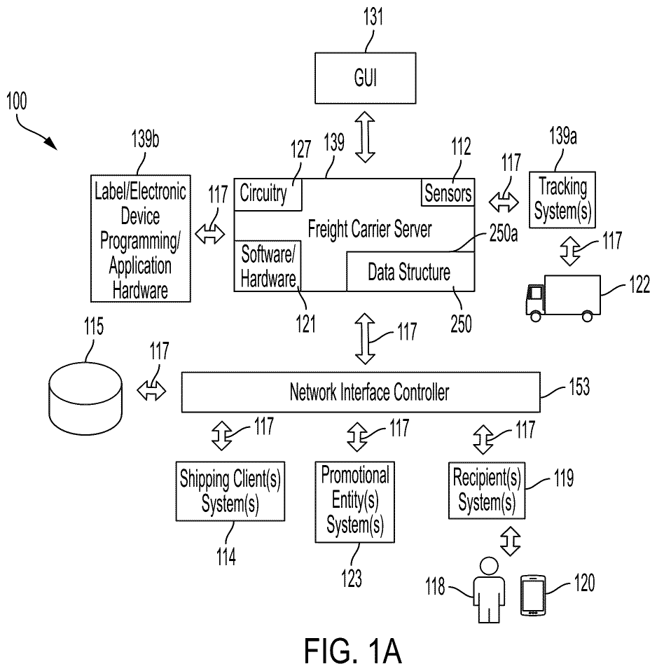

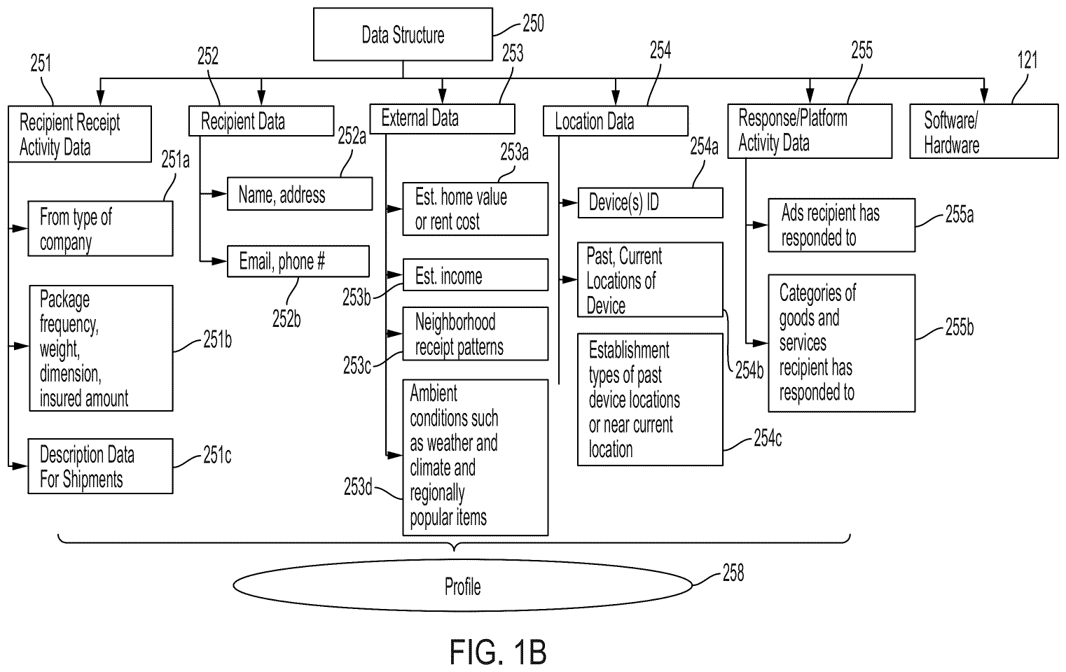

FIG. 1A illustrates a system 100 for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated with the package for delivery or a demographic profile of a package recipient, in accordance with embodiments of the present invention. Typical advertising systems are associated with selecting a targeted advertisement based on a consumer advertising profile. Likewise, targeted information may be retrieved via usage of a personal information database and personal order sheets associated with previous orders of a user. Furthermore, typical processes for generating targeted advertisements may include methods for scanning an entire package to determine contents and generating promotions for placement on the package based on the scanned contents thereby potentially providing inaccurate results with respect to a promotional type for presentation to a package recipient. Therefore, the method and associated system of the present invention is configured to enable a process for generating and presenting a physical or digital visible promotional structure associated the package for delivery (during a real time delivery process being executed during a current time frame) thereby improving an accuracy of delivery based promotions.

System 100 enables freight carriers to determine shipment order contents and build complex customer demographic profiles. Likewise, system 100 enables freight carrier clients to opt into a shipment order content system for specifying items being shipped in each order with respect to item/package recipients thereby enabling a freight carrier to generate recipient demographics and cross-promotional opportunities.

System 100 is configured to enable a process for allowing a freight carrier customer (i.e., a shipping client) to provide item descriptions (e.g., via a sku barcode, etc.) and/or categories of products (within a package) being sent to a freight carrier for shipping to a recipient. In response, the freight carrier may build a demographic profile of package recipients with respect to products received from multiple freight carrier customers. Subsequently, the freight carrier may cross-reference products (within a package) with respect to a package identifier (e.g., a bar code) and/or a package recipient name and/or address. The freight carrier may retrieve and accumulate shipment information and associate the shipment information with a recipient name and/or address.

System 100 further enables a freight carrier customer to permit additionally selected freight carrier customers to associate promotional offers to multiple shipped orders or to permit freight carrier-served digital promotions to digital contacts of profiled recipients of a shipping customer. The additionally selected freight carrier customers are enabled to present promotions to package recipients specified within the demographic profiles (as describe, supra). Likewise, the freight carrier may attach a physical and/or digital (e.g., QR code, bar code, RFID tag, etc.) label (comprising the promotional offer) to a package comprising order contents. Additionally, the freight carrier may and may host the promotional offer digitally on an order tracking page. System 100 may further enable multi-vendor shopping platform operators or digital ecommerce wallet operators in addition to freight carriers. A digital ecommerce wallet operator may comprise an e-commerce checkout platform that retains an online shopper identity associated with a created account. The e-commerce checkout platform may allow a shopper to execute an online purchase with one enabling click across all member merchants (Instead of signing in to each individual merchant). Likewise, e-commerce checkout platform may be enabled to track online item selection and cart contents from each merchant. A digital ecommerce wallet operator may be configured to collect items selected by shoppers (or shopper shopping cart item contents) and perform promotion generation and presentation via digitally served offers to profiled shoppers.

System 100 of FIG. 1A includes a freight carrier server 139, a tracking system 139a (communicating with a shipping vehicle 122), programming/application hardware 139b, shipping client systems 114, promotional entity systems 123, (package) recipient systems 119, a database 115, and network interface controller 153 interconnected through a network 7. Freight carrier server 139, tracking system 139a, and promotional entity systems 123 are each independent from and located external to each other. For example, each of freight carrier server 139, tracking system 139a, and promotional entity systems 123 may be located at differing geographical locations. Freight carrier server 139 comprises sensors 112, circuitry/logic 127, a specialized graphical user interface (GUI) 131 (performing specialized presentation functionality associated with presentation of data of data structure 250 for analysis and computer code programming/modification), software/hardware 121, and at least one specialized memory structure 250a for storing computer program comprising a data structure 250 described with reference to FIG. 1B, infra.

In a first embodiment, the data structure 250 and the software/hardware 121 are separated from each other as depicted in FIG. 1A. In a second embodiment, the data structure 250 encompasses the software/hardware 121 of FIG. 1A as depicted in FIG. 1B described infra. Thus in the preceding second embodiment, the content of the software/hardware 121 resides within the data structure 250.

Programming/application hardware 139b comprises a hardware/software structure configured to generate a promotional label (e.g., a visible promotional label, a UPC label, a SKU label, etc.) and/or program an electrical device (e.g., an RFID tag) for presenting (visibly or electronically via e.g., a mobile device) a promotion to a package recipient. Likewise, programming/application hardware 139b comprises a hardware/software structure configured to apply (e.g., automatically via a robotic device) a promotional label (e.g., a visible promotional label, a UPC label, a SKU label, etc.) and/or an electrical device for presenting a promotion to a package recipient. Freight carrier server 139, tracking system 139a, programming/application hardware 139b, shipping client systems 114, promotional entity systems 123, and recipient systems 119 each may comprise an embedded device(s). An embedded device is defined herein as a dedicated device or computer comprising a combination of computer hardware and software (fixed in capability or programmable) specifically designed for executing a specialized function. Programmable embedded computers or devices may comprise specialized programming interfaces. In one embodiment, freight carrier server 139, tracking system 139a, programming/application hardware 139b, shipping client systems 114, promotional entity systems 123, and recipient systems 119 may each comprise a specialized hardware device comprising specialized (non-generic) hardware and circuitry (i.e., specialized discrete non-generic analog, digital, and logic-based circuitry) for (independently or in combination) executing a process described with respect to FIGS. 1-7. The specialized discrete non-generic analog, digital, and logic-based circuitry (e.g., sensors 112, circuitry/logic 127, software/hardware 121, etc.) may include proprietary specially designed components (e.g., a specialized integrated circuit, such as for example an Application Specific Integrated Circuit (ASIC) designed for only implementing an automated process for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated the package for delivery. Sensors 112 may include any type of internal or external sensors including, inter alia, GPS sensors, Bluetooth beaconing sensors, cellular telephone detection sensors, Wi-Fi positioning detection sensors, triangulation detection sensors, activity tracking sensors, a temperature sensor, an ultrasonic sensor, an optical sensor, a video retrieval device, humidity sensors, voltage sensors, network traffic sensors, etc. Delivery vehicle 122 may include a memory system, software, video recording devices (e.g., a video camera), and motion control hardware (all sensors and associated control hardware for executing a process for directing delivery vehicle 122 to deliver a package to a specified location). Vehicle 122 may comprise any type of vehicle that includes a human operator located within vehicle 122 (e.g., an aircraft, an automobile or truck, a boat or ship, a train, etc.) for enabling a package delivery process. Alternatively, vehicle 122 may comprise any vehicle that does not require a human operator to be located within the vehicle 122 such as, inter alia, a remote controlled vehicle (e.g., an aircraft flown by a pilot at a ground control station), an autonomously controlled vehicle (e.g., an aircraft controlled based on pre-programmed flight plans and may include an intelligence algorithm that would enable a vehicle to know it's location and self-determine a route to deliver a package to a location dynamically), a pre-programmed vehicle, etc. Vehicle 122 may include, inter alia, an aerial vehicle, a land-based vehicle, a marine (water) based vehicle, etc. Vehicle 122 may include sensors (within vehicle 122) including, inter alia, GPS sensors, temperature sensors, pressure sensors, cameras, infrared sensors, motion sensors, a microphone, optical sensors, a thermal imaging apparatus/sensor, optical and vibrational sensors, voltage sensors, RFID sensors, etc. Network 7 may include any type of network including, inter alia, a local area network, (LAN), a wide area network (WAN), the Internet, a wireless network, etc.

System 100 is enabled to execute a process for generating a printed or electronic structure for presenting a promotion as follows:

The process is initiated when a freight carrier receives (from a first shipping client via an opt-in interface) electronic data (associated with a package comprising products for shipment) including shipment IDs, package recipient names and addresses, and data indicating contents of packages (e.g., retrieved via an item bar code, a UPC, a sku structure, an item description, a category, etc.). Subsequently, the electronic data is utilized for generating a demographic profile for each package recipient. Additionally, an interface is presented (to the first shipping client) for enabling or disabling additional shipping clients to generate and present promotions on a package or associated shipment tracking page of the first shipping client. A subsequent cross-referencing process may be executed as follows:

The associated shipment tracking page is cross referenced with (shipping client enabled) additional shipping clients enabled to present a promotion via a tracking page associated with a demographic of a package recipient associated with the tracking page. Likewise, available tracking pages are matched with a number of promotions desired by additional shipping clients with respect to matched package recipient demographics. A bidding process may be enabled with respect to selecting the additional shipping clients such that a relationship between a desired number of promotions exceeds available shipment tracking pages with respect to a specified interval of time. In response to the aforementioned cross-referencing, a specified shipping client is enabled to present promotions on an associated tracking Webpage. The cross-referencing process results in the generation of a promotion (e.g., in the form of a label comprising the promotion in a visible format, a QR code for communications with and promotion presentation to a mobile device of a package recipient, an RFID tag for communications with and promotion presentation to a mobile device of a package recipient, etc.) for placement on a package or an associated tracking page of the first customer.

System 100 additionally enables the following functionality:
1. Enabling a shipping client (e.g., via a specialized interface such as, inter alia, specialized hardware/software, a virtual reality interface, mobile device interface, etc.) to enter shipping package contents and/or item value (of shipping package contents) in combination with order/shipment data for generating a package recipient(s) profile.
2. Enabling a freight carrier to present promotion based on information within a package recipient(s) profile (via digital communications such as, inter alia, email, text message, encrypted digital communications, etc.). Likewise, a freight carrier is enabled to present promotions via package recipient communications (e.g., email, phone communications, etc.). Likewise, a freight carrier may be enabled to offer promotion placement to promotional entities unrelated to current freight carrier package shipments.
3. Enabling a reverse bidding process (initiated by shipping clients) to retrieve additional promotions and associated revenue such that a current supply of desired profiled recipients is greater than a demand for promotions (e.g., multiple shipping clients are associated with pending package recipients comprising similar profiles exceeding a promotion demand.
4. Shipping clients are enabled to provide recipient demographics for promotion presentation with respect to freight carrier generated package recipient demographics associated with multiple orders received by package recipients.
5. Shipping clients are enabled to select promotional entities for placement of promotions on packages or associated package tracking Webpages of a freight carrier(s) independent from whether a promotional entity comprises a shipping customer of the freight carrier presenting promotions. The freight carrier may select desired promotion placement with respect to authorized combinations of shipping clients associated with in-transit packages and promotional entities.
6. Enabling recipient profiling based on elements such as, inter alia, a category of package recipient purchases, a frequency of package recipient purchases, a value of package recipient purchases, an estimated home value of package recipients, an estimated income of package recipients, address data of package recipients, time series and rate of change data associated with package recipients, responses of package recipients with respect to previous promotions, specific types, quantities, or combinations of items or categories of items purchases/received over time, responses to previous freight carrier digital promotions unrelated to current package shipments, etc.

System 100 is configured to deploy an electronically generated promotional structure as described in the following example process scenario:

The process is initiated when a freight carrier (e.g., a parcel service, a government postal service, etc.) builds and enables a hardware/software platform (e.g., freight carrier server 139, tracking system 139a, and programming/application hardware 139b of FIG. 1A). Shipping clients A, B, and C (e.g., entities providing products for shipment to package recipients) are enabled to opt in (with the freight carrier) to provide the hardware/software platform with data describing item contents for each shipment being sent via the freight carrier. For example, shipping clients A, B, and C may opt in to provide (via a specialized computer interface application programming interface (API)) order identification data (for each shipment) such as, inter alia, an order number, a package recipient(s) name and address, item contents within each order including an item number, a universal product code (UPC), a product description, and a product category for each item.

In response, the freight carrier utilizes the order identification data to build package recipient profiles comprising items received (by the package recipient(s)) and/or package recipient addresses with respect to multiple orders executed via multiple shipper clients (e.g., shipping clients A, B, and C). Associated profiles (for the multiple shipping clients) may further include order weight(s), order dimensions, an estimated residence value of a package recipient(s), an estimated income of a package recipient(s), etc. An algorithm (implemented via specialized software code) may be enabled to generate profiles for package recipients with respect to, inter alia, product types received, a frequency of product receipt, categories of products received, a breadth and depth (i.e., volume) of items received across multiple categories, a number of shippers from which various product categories are received, etc.

The freight carrier may further enable shipping clients A, B, and C to allow alternative shipping clients to generate and apply promotional structures (e.g., a visible promotional label, a UPC label, a SKU label, etc. and/or an electrical device (e.g., an RFID tag) for presenting (visibly or electronically via e.g., a mobile device)) to packages of shipping clients A, B, and C. Likewise, the freight carrier may further enable shipping clients A, B, and C to allow the alternative shipping clients to generate promotions for presentation via Web based tracking pages for the packages or within email (e.g., confirmation email) or SMS (phone texts or messages) transmitted to recipients via the freight carrier. The freight carrier hardware/software platform may comprise and enable specialized filters for allowing shipping client A, B, and C to enable or disable promotions with respect to a name of a company or industry. Therefore (for any given package in transit by any given company), a number of additional companies may be enabled to promote in association with a package.

The freight carrier may further generate software programming code executed for matching desired package recipient demographics comprising potential promotional entities to available demographics of package recipients of in-transit packages. Furthermore, the potential promotional entities may require that promotional structures only be placed on packages of package recipients that are not current or past customers of the freight carrier. The aforementioned process may be executed by enabling the potential promotional entities to provide names and addresses to the freight carrier or by enabling the freight carrier to exclude package recipients of package shipments from the potential promotional entities by querying its own delivery archives. A subsequent matching process may be executed to compare an aggregate demand by package recipient profile type from multiple potential promotional entities to an available supply of promotions. Likewise, a bidding process may be executed to match a demand and supply of promotions. The bidding process may comprise a tiered process with respect to a relative association with any given package recipient profile. That association may comprise a function of breadth and depth of package recipient activity across desired product types or categories over time. Alternatively, association may comprise a function of a promotion response history tracked by the freight carrier hardware/software platform. A matching and bidding process may be further executed to target with respect to a promotion on a package or a digital promotion on a tracking Web page, etc.

When a promotion is matched to a package recipient, the hardware/software platform is enabled to monitor packages (for delivery) with desired promotions applied physically to the packages (e.g., via a physical promotion applicator such as programming/application hardware 139b) and directing the physical promotion applicator to apply the promotion to the package. Additionally, the hardware/software platform may be enabled to present desired promotions to: Web tracking pages of package orders in-transit to the targeted package recipients and/or in delivery confirmation emails, texts, or alternative digital means.

The hardware/software platform may further be enabled to: track promotion related behavior of package recipients; charge fees per type of promotion, and/or may enable revenue-sharing agreements with shipping clients allowing promotions. Associated data retrieved during the aforementioned process may enable additional services such as, inter alia, provisioning item or category aggregate demand data by geographic area, shipping client scoring capability for recipients, a recipient community based on a similarity of demand (e.g., recipients receiving similar categories of items), etc.

Shipping clients may additionally be provided with data describing a degree associated with any combination of shippers sharing recipient profiles or a degree to which shipping clients retain desired demographic recipient profiles of alternative shipping clients.

System 100 is configured to further deploy an electronically (e.g., via specialized hardware and software implemented circuitry of e.g., label/electronic device programming/application hardware 139b) generated promotional structure as described in the following process scenario:

A freight carrier (without approval from a shipping entity) enables a process for printing (via electronic hardware or software means such as specialized hardware or software printing apparatuses, software electronic document structures such as a PDF file, etc.) promotional offers associated with a package recipient demographic and physically delivers the printed promotional offers during package delivery (i.e., the freight carrier does not apply the printed promotional offers to the package. System 100 enables the following process associated with physically delivering printed promotional offers during package delivery:

The process is initiated when a freight carrier generates package recipient profiles as described, supra. Likewise, a shipping client may contact the freight carrier for promotional structure generation and placement. In response, the freight carrier generates (e.g., prints) promotional structures (e.g., flyers) that are unique for specific package recipients associated with a shipping client's desired profile for the promotional structures. Subsequently, promotional structures are delivered to the package recipient during a package delivery process executed by the freight carrier. The aforementioned process does not require any type of authorization from the shipping entity thereby enabling a physical promotional structure to be printed for association with a data structure configured to a package recipient address.

System 100 is configured to further deploy an electronically generated promotional structure as described in the following alternative process scenario:

A freight carrier enables a process for providing shipping client/entity approved promotional structures from additional shipping client/entities. The promotional structures are provided to a package recipient via a physical or digital packing slip or a package status email transmitted from the original shipping client/entity thereby leveraging demographic profiles generated by the freight carrier entity with respect to promotions associated with the additional shipping client/entities (i.e., using the original shipping client/entity infrastructure). System 100 enables the following process associated with providing the promotional offers prior to, during, or subsequent to package delivery:

The process is initiated when a freight carrier system matches an authorized promotional entity to a shipping client/entity and package recipient such that the shipping client/entity system transmits a message comprising pending shipments to the freight carrier carrier system. The message may include, inter alia, a recipient address and associated tracking numbers. In response, the freight carrier transmits authorized promotional structures (generated based on package recipient demographics matched to a physical address associated with a tracking number and desired demographics of the package recipient) to the shipping client/entity. Subsequently, the shipping client/entity is enabled to print a promotional structure a packing slip or insert in the promotional structure within a package. Alternatively, the shipping client/entity is enabled to deploy the promotional structure digitally within an electronic shipment notification or digital packing slip transmitted to a package recipient.

FIG. 1B illustrates an exploded view of the data structure 250 of FIG. 1A, in accordance with embodiments of the present invention. In a first embodiment, the data structure 250 and the software/hardware 121 are separated from each other as depicted in FIG. 1A. In a second embodiment, the data structure 250 encompasses the software/hardware 121 of FIG. 1A as depicted in FIG. 1B. Thus in the preceding second embodiment, the content of the software/hardware 121 resides within the data structure 250.

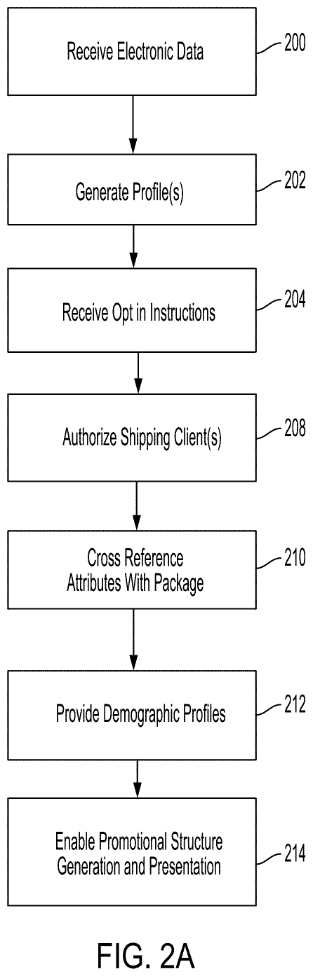

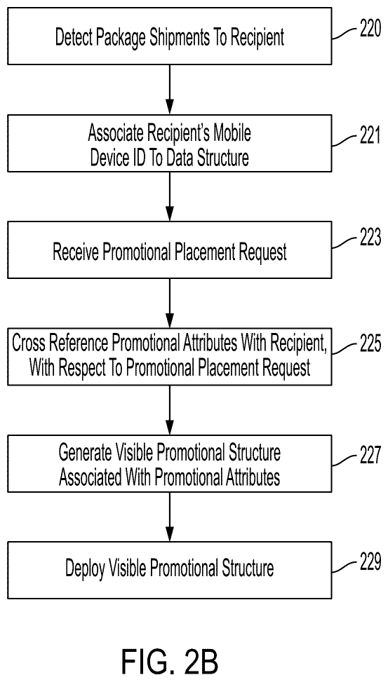

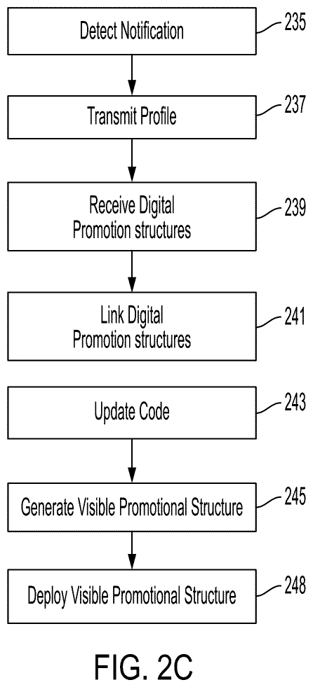

Software/hardware 121 comprises specialized computer code, and associated data, created and updated by a modifiable computer program product comprising specialized instructions executable for generating and deploying a physical or digital promotional structure for a package recipient in accordance with the steps of FIGS. 2A-2C. Software/hardware 121 comprises a plurality of specialized modifiable (based on execution and feedback from freight carrier server 139 of FIG. 1A) computer code modules executable for automated detection of package shipments and generating (i.e., constructing) and deploying a physical or digital promotional structure for a package recipient. Software/hardware 121 comprises an instruction set for modifying an operation and functionality of software/hardware of freight carrier server 139 of FIG. 1A. Modifying an operation and functionality of software/hardware of freight carrier server 139 comprises updating and modifying code of code modules based on feedback from system 100 of FIG. 1A. The updated and modified code of code modules operationally modifies a functionality of freight carrier server 139.

Data structure 250 comprises at least one profile 258 comprising data items (e.g., relating to the recipient of a package). Each profile of the at least one profile 258 includes data items grouped under categories of: recipient receipt activity data 251, recipient data 252, external data 253, location data 254, and response/platform activity data 255.

Receipt activity data 251 includes the following data items: a type of company from which the package originated 251a; package frequency (of being sent), package weight, package dimensions, and insured amount of package content 251b; and description data associated with the package shipments (e.g., description of package content; shipment identification data for the package shipments) 251c. The description data 251c may also include a bar code structure, a universal product number (UPC) structure, stock keeping unit (SKU) code structure, and a radio frequency identification (RFID) structure.

Recipient data 252 includes the following data items: name and address of recipient 252a; and email address and phone number (landline or cell phone) of recipient 252b.

External data 253 includes the following data items: estimated home value or rental cost 253a; estimated income 253b; neighborhood receipt patterns 253c; and ambient conditions such as weather, climate, and regionally popular items 253d.

Location data 254 includes the following data items: an identification (ID) of one or more user device(s) 254a; past and/or current locations of device 254b, and establishment types of past device locations or near past and/or current locations 254c. In one embodiment, the one or more user device(s) 254a includes one or more mobile devices.

Response platform activity data 255 includes data items of: ads that recipient has responded to 255a and categories of goods and services that recipient has responded to (e.g., via shopping and/or purchasing) 255b.

An algorithm (executed via computer code) may act upon data structure 250 (one or more times) to ascribe a demographic attribute (executed via any of code modules) to data structure 250 which attribution is a function of archived shipment-related data and rules (executed via code modules) that derive one or more demographic attributes that are associated with data structure 250. A demographic attribution algorithm may be executed for deriving a gender, an income level, a home value level associated with a package recipient address, and consumption preferences associated with categories of items received, a frequency of receipt, combinations of items received, seasonal patterns of such receipts, and additional aspects that may be derived from receipt data.

A specialized computer program (e.g., software/hardware of 121 of FIG. 1A or FIG. 1B) may be generated for matching demographic attributes of data structures associated with parcel recipients to locate relevant commonalties among promotional entity-desired attribute combinations and those of package recipients. Demographic attributes may include, inter alia, income levels and propensities to consume certain types of goods or combinations of goods.

Data structure 250 may additionally comprise an archive of inventory items/lots and an archive of orders. The archive of inventory items/lots comprises (for each item/lot), an item ID, quantity, serving days, and expiration.

In some embodiments, the data structure 250 associates the archive of inventory items/lots with the archive of orders. In some embodiments, the archive of orders comprises, for each customer/store order, an order ID, a physical order, and the digital packing slip of the order ID.

In some embodiments, the computer program product (e.g., software/hardware of 121 of FIG. 1A) encodes data structure 250 (via execution of code module) with a value comprising a result of subtracting from a lot expiration date, a reference date, such as the difference between the expiration date of each lot and a reference date, the difference between the time difference and the serving days. In some embodiments, data structure 250 includes an encoded value comprising the result of subtracting from an order receipt date by a recipient and/or further subtracting the consumption days of the item. The computer program product creates and continuously updates/modifies a new data structure 250 (via execution of code modules) at a predetermined frequency (e.g., after each time or day).

In some embodiments, data structure 250 can be extended to mapping to a GUI or an email containing an item and price offer to a customer and mapping the email to an electronic item purchase order specifying a minimum expiration date of a lot of an ordered item. For example, data structure 250, through a sequence of programs, may cause a marketing and promotions program to display a price offer associated to an item archived in the data structure 250 via a GUI. Similarly, data structure 250 causes, through a series of programs, an electronic purchase order to specify an earliest acceptable lot expiration date.

A communication module (e.g., of data structure 250 and/or software/hardware of 121) may be configured to receive and store information pertaining to each item or lot in an inventory from data structure 250. Data structure 250 maintains information of each item or lot including but not limited to:

Item or product description

SKU number

Lot number

Number of available pieces of an item or product of each lot in an inventory

Inventory pick locations

Quantity by location of inventory for each item or product

Expiration date (or expiry) of each lot

Servings units per container of each item or product

Recommended daily dose

Days of servings (serving units divided by recommended daily dose)

Historic rates of sale of units of an item or product regardless of lot

Current orders or open orders for an item or product

Sales forecast or rate of sale (number of items sold per day)

Expected receipt dates for an item or product

Likewise, one or more processors (of freight carrier server 139 of FIG. 1A) may run a computer program executing steps for calculating days of sales of an entire inventory and/or an effective expiry similar to those described above, at intervals or continuously based on received item information from data structure 250.

In some embodiments, an expiry validation program performs, via the processors, a reversed calculation, i.e., the difference of serving days and days to expiry. After the calculation, the processors record the results in data structure 250 for future execution.

FIG. 2A illustrates an algorithm detailing a process flow enabled by system 100 of FIG. 1A for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated the package for delivery or a demographic profile of a package recipient, in accordance with embodiments of the present invention. Each of the steps in the algorithm of FIG. 2A may be enabled and executed in any order by a computer processor(s) executing computer code. Additionally, each of the steps in the algorithm of FIG. 2A may be enabled and executed in combination by freight carrier server 139, tracking system 139a, programming/application hardware 139b, shipping client systems 114, promotional entity systems 123, and recipient systems 119. In step 200, electronic data is received by a server of a freight carrier. The electronic data may be received from the freight carrier entity. The electronic data may be received from the freight carrier from a portal system(s) of the freight carrier. The portal system may include item order information associated with packages for package recipients or a carrier-operated imaging system configured to determine item attributes within a sealed package. The electronic data includes shipment identification data for a shipment of an item(s) from a shipping client(s) to a package recipient(s); a recipient name and address for the package recipient(s), and description data associated with the item(s). The description data may be comprised by a structure such as, inter alia, a bar code structure, a universal product number (UPC) structure, a stock keeping unit (SKU) code structure, a radio frequency identification (RFID) structure, etc.

In step 202, a profile(s) is generated for the package recipient(s) based on the electronic data retrieved in step 200. The profile may include data associated with a type of company of the shipping client(s), specified types of products associated with the shipping client(s), a size of packages received by the recipient(s), a weight of packages received by the the recipient(s).

In step 204, opt in instructions are received from the shipping client(s) via an interface (e.g., a hardware/software interface, a virtual interface, etc.). The opt in instructions may include permission for enabling an additional shipping client(s) (of the freight carrier) to generate promotions in association with packages being delivered by the freight carrier. The opt in instructions may further include permission enabling at least one additional shipping client of the freight carrier to generate promotions in association with the package(s).

In step 208, additional shipping clients (of the freight carrier) are authorized to generate visible promotional structures associated with specified packages for delivery by the freight carrier. In step 210, promotional attributes from the additional shipping clients are cross referenced (based on results of step 208 and in response to analysis of the profile(s)) with the package(s) comprising the item(s) for the recipient(s). The cross-referencing process may include matching demographic profiles (of further recipients of pending delivery packages) to additional demographic profiles selected by at least one authorized promotional entity from at least one further shipping client for each pending delivery package. In step 212, the demographic profiles and additional demographic profiles are presented (or provided to) the shipping client(s) and the at least one further shipping client. In step 214, (at least one) visible promotional structure associated with the promotional attributes is generated for the recipients. The visible promotional structure may include a physical structure attached to the package(s) and/or a digital structure configured to be presented to the recipient(s) via a hardware and software user interface. The visible promotional structure may be presented to the recipient(s) during a delivery process of the package(s) or in a digital form at any time after the package recipient has been profiled. Additionally, a plurality of item recipients and a plurality of different freight carrier entities may be authorized (in response to instructions from the freight carrier entity) to generate and present additional visible promotional structures associated with further specified packages for delivery by the freight carrier to different recipients receiving shipped orders from the freight carrier entity. Additionally, entities (associated with further shipping clients) may be authorized to provide the visible promotional structure to a profiled package recipient(s) associated with the further shipping clients and associated Web-based tracking pages. Demographics of the profiled package recipient(s) are provided by the further shipping clients.

Generating the visible promotional structure may include any combination of the following processes:

Generating the visible promotional structure may include enabling a Web-based tracking page associated with the package(s) for allowing the at least one further shipping client to promote a demographic associated with the recipient(s) via the Web-based tracking page. Likewise, additional authorized Web-based tracking pages for packages may be matched to a number of promotional structures associated with the at least one further shipping client with respect to the demographic of the recipient(s). A resulting bidding process may be enabled. The bidding process is enabled for the shipping clients and the least one further shipping client with respect to visible promotional placement with respect to the package(s) such that a number of promotional structures in combination with visible promotional structure(s) promotions exceeds a number of available Web-based tracking pages associated with the freight carrier over a given interval of time. Presenting the visible promotional structure may include presentation via the Web-based tracking page for tracking a vehicle associated with delivery of the package(s). The Web-based tracking page may include a static tracking page for providing static type tracking information for tracking the vehicle associated with delivery of the package(s). Alternatively, the Web-based tracking page may include a dynamic tracking page for providing dynamic real time continuously updating tracking information for the package(s). The visible promotional structure may include multiple differing promotions presented to the recipient(s) based on differing real-time locations of the vehicle associated with delivery of the package(s). The multiple differing promotions are associated with businesses located near to the differing real-time locations of the vehicle. Additionally, geographical information associated with the businesses may be retrieved from a database of known locations. The geographical information associated with the businesses may be detected via sensors of the vehicle as the vehicle is moving past the businesses.

Generating the visible promotional structure may include generating at least one label comprising a visible promotion for presentation to the recipient(s). Likewise, presenting the visible promotional structure may include applying the at least one label to the package(s). Applying the at least one label to the package(s) may include, inter alia, a manual process performed by a person, an automated process performed by a machine (e.g., a robotic device).

Generating the visible promotional structure may include generating at least one label comprising a QR code associated with a visible promotion for presentation to the recipient(s). Presenting the visible promotional structure includes enabling communications between the QR code and a mobile device(s) of recipient(s) such that the mobile device(s) present visible promotion to the recipient(s).

Generating the visible promotional structure may include generating data associated with a visible promotion for presentation to the recipient(s) and transferring the data to a RFID tag(s). Likewise, presenting the visible promotional structure may include applying the the RFID tag(s) to the package(s) and enabling communications between the RFID tag(s) and a mobile device(s) of the recipient(s) such that the mobile device(s) presents the visible promotion to the recipient(s).

FIG. 2B illustrates a first alternative algorithm detailing a process flow enabled by the system of FIG. 1A for improving software implemented promotional structure generation technology associated with and generating and deploying a physical or digital visible promotional structure associated with the package for delivery or a demographic profile of a package recipient, in accordance with embodiments of the present invention. Each of the steps in the algorithm of FIG. 2B may be enabled and executed in any order by a computer processor(s) executing computer code. Additionally, each of the steps in the algorithm of FIG. 2B may be enabled and executed in combination by freight carrier server 139, tracking system 139a, programming/application hardware 139b, GUI 131, shipping client systems 114, promotional entity systems 123, and recipient systems 119. FIG. 2B describes multiple embodiments comprising execution of step 220 and/or step 221. Such embodiments encompass executing step 220, executing step 221, or executing step 220 and step 221.

In step 220, package shipments are detected. The package shipments were previously shipped, or are currently being shipped, from a client hardware system 114 of a client to at least one recipient in recipient systems 119. The client hardware system 114 is located external to the server 139. Package shipments may be detected via data detection processes associated with monitoring data within data structure 250 of FIG. 1A or FIG. 1B, or being transmitted across network 117. Alternatively, package shipments may be detected via usage of hardware/software sensors being activated during communication between freight carrier server 139 and packages of the package shipments. For example, package shipments may comprise sensors (e.g., RFID or NFC sensors) communicating with circuitry of the freight carrier server during processing and travel of the packages.

In step 221, an identifier (ID) of a mobile device of at least one recipient is associated to the data structure 250. In one embodiment, the mobile device ID of the at least one recipient is included within item 254a of the data structure 250. In one embodiment, the address of at least one recipient may be associated to the mobile device ID of the at least one recipient.

The data structure 250 of FIG. 1B) is executed with respect to (data identifying) the recipient (e.g., via a cross-referencing process). The data structure may include a digital representation of electronic data comprising a profile for the recipient. The profile may comprise information including: shipment identification data for the package shipments, a recipient name and address for the recipient, and description data associated with the package shipments. The description data associated with the item is comprised by a specialized structure that may include a bar code structure, a universal product number (UPC) structure, stock keeping unit (SKU) code structure, and a radio frequency identification (RFID) structure.

In step 223, a promotional placement request is received from a promotional client entity 123. The promotional placement request is associated with promotions with respect to attributes of the at least one recipient within the data structure 250 that includes a digital representation of electronic data comprising at least one device identification attribute associated with a hardware device (e.g., mobile device in one embodiment) 254a of the at least one recipient and at least one profile 258 for the least one recipient. The at least one profile 258 is depicted in FIG. 1B and comprises a recipient name and address 252a for the at least one recipient, past and/or current locations 254b of the hardware device (e.g., mobile device in one embodiment) of the at least one recipient, and description data for shipments associated with the package shipments 251c (e.g., description of package content; shipment identification data for the package shipments). The description data 251c may also include a bar code structure, a universal product number (UPC) structure, stock keeping unit (SKU) code structure, and a radio frequency identification (RFID) structure.

In step 225, promotional attributes from the client with the at least one recipient are cross referenced with respect to the received promotional placement request.

In step 227, at least one visible promotional structure associated with the promotional attributes is electronically generated (e.g., via specialized hardware and software code) for the client with respect to the recipient. In one embodiment, electronically generating the at least one visible promotional structure is based on any one or more data items in the data structure. For example, the one or more data items in the data structure, upon which said electronically generating the at least one visible promotional structure is based, comprises inter alia: a past and/or current location of the mobile device, one or more advertisements that the at least one recipient has responded to, one or more categories of goods and services that the at least one recipient has responded to, the address of the at least recipient, the email of the at least recipient, an estimated home value or rental cost of the at least one recipient, an income of the at least one recipient, and combinations thereof.

In step 229, the at least one visible promotional structure is deployed to the recipient during a real time delivery process of the package. The deployment process may include: printing a structure comprising the at least one visible promotional structure; and further deploying the structure with the package during the real time (a current time of the delivery process) delivery process of the package to the recipient. The structure may be deployed as an independent structure with respect to the package (i.e., not attached to the package) during the real time delivery process the package to the recipient.

In one embodiment of step 229, the at least one visible promotional structure may be deployed by being transmitted to a mobile device of the at least one recipient in real time, wherein the transmitted at least one visible promotional structure is visible on the mobile device (e.g., as a popup, text, icon, etc.).

Alternatively, the deployment process may include: receiving (from the recipient) approval for transmitting promotional structures; generating (in response to the approval) an email (or alternative transmittable structure such as, inter alia, a text message, a mobile phone notification, etc.) comprising the at least one visible promotional structure; and transmitting the email (or alternative transmittable structure) to the recipient before, during, or subsequent to the real time delivery process of the package.

FIG. 2C illustrates a second alternative algorithm detailing a process flow enabled by the system of FIG. 1A for improving software implemented promotional structure generation technology associated with and generating and deploying a physical or digital visible promotional structure associated with the package for delivery or a demographic profile of a package recipient, in accordance with embodiments of the present invention. Each of the steps in the algorithm of FIG. 2C may be enabled and executed in any order by a computer processor(s) executing computer code. Additionally, each of the steps in the algorithm of FIG. 2C may be enabled and executed in combination by freight carrier server 139, GUI 131, tracking system 139a, programming/application hardware 139b, shipping client systems 114, promotional entity systems 123, and recipient systems 119.

In step 235, a notification specifying package shipments available for a recipient is detected (by a freight carrier server 139) is detected from a client hardware system 114 of a client. The notification may be detected via data detection processes associated with monitoring data within data structure 250 or being transmitted across network 117. Alternatively, the notification may be detected via usage of hardware/software sensors 112 being activated during communication between freight carrier server 139 and packages of the package shipments.

In step 237, at least one profile 258 is transmitted (via a communications protocol over a data network 117 of promotional client entity hardware systems 123 located external to the server 139 and the client hardware system 114) to authorized promotional client entities. The at least one profile 258 is configured as a digital representation of electronic data. The at least one profile 258 comprises, as depicted in FIG. 1B, a recipient name and address 252a for the at least one recipient and descriptive data for shipments 251c which may include shipment data for package shipments and description data associated with the package shipments (e.g., a bar code structure, a universal product number (UPC) structure, stock keeping unit (SKU) code structure, and a radio frequency identification (RFID) structure).

In step 239, digital promotional structures cross-referenced to the at least one profile of the least one recipient are received from at least promotional client entity of the authorized promotional client entities. The digital promotional structures are stored in a data store (e.g., in the data structure 250).

In step 241, the digital promotional structures are linked to the data structure 250 that includes executable instructions embedded within computer code and the digital representation of electronic data.

In step 243, computer code of the data structure 250 is continuously updated based on results of the aforementioned steps.

In step 245, at least one visible promotional structure associated with the digital promotional structures is electronically generated for the client with respect to the recipient via the communication protocol.

In step 248, the at least one visible promotional structure is deployed (in real time) to the client such that the client is enabled to physically or digitally deploy the at least one visible promotional structure to the at least one recipient.

The deployment process of step 248 may include printing a physical packing slip comprising the at least one visible promotional structure and a contents listing for the package; and placing the physical packing slip with the package for deployment during the real time delivery process of the package to the recipient.

Alternatively, the deployment process may include: generating a digital packing slip comprising the promotional structure and a contents listing for the package; and transmitting the digital packing slip to the recipient before, during, or subsequent to a real time delivery process of the package.

As a second alternative, the deployment process may include: generating an electronic shipping notification comprising the visible promotional structure; and transmitting the electronic shipping notification to the recipient before, during, or subsequent to a real time delivery process of the package.

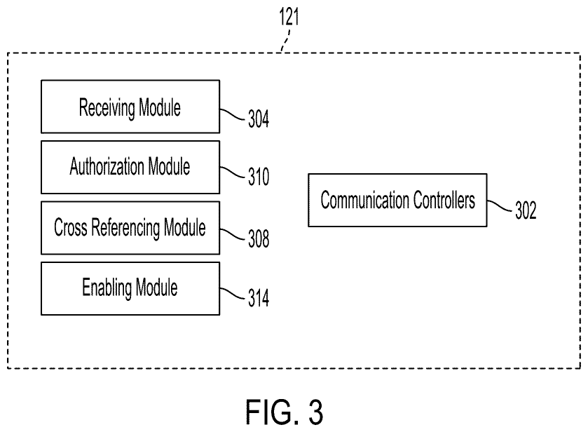

FIG. 3 illustrates an internal structural view of software/hardware 121 of FIG. 1A, in accordance with embodiments of the present invention. Software/hardware 121 includes receiving module 304, an authorization module 310, a cross-referencing module 308, an enabling module 314, and communication controllers 302. Receiving module 304 comprises specialized hardware and software for controlling all functions related to the receiving steps of FIG. 2. Authorization module 310 comprises specialized hardware and software for controlling all functionality related to the authorization steps described with respect to the algorithm of FIG. 2. Cross-referencing module 308 comprises specialized hardware and software for controlling all functions related to the cross-referencing steps of FIG. 2. Enabling module 314 comprises specialized hardware and software for controlling all functions related to the enabling and presentation steps of the algorithm of FIG. 2. Communication controllers 302 are enabled for controlling all communications between receiving module 304, authorization module 310, cross-referencing module 308, and enabling module 314.

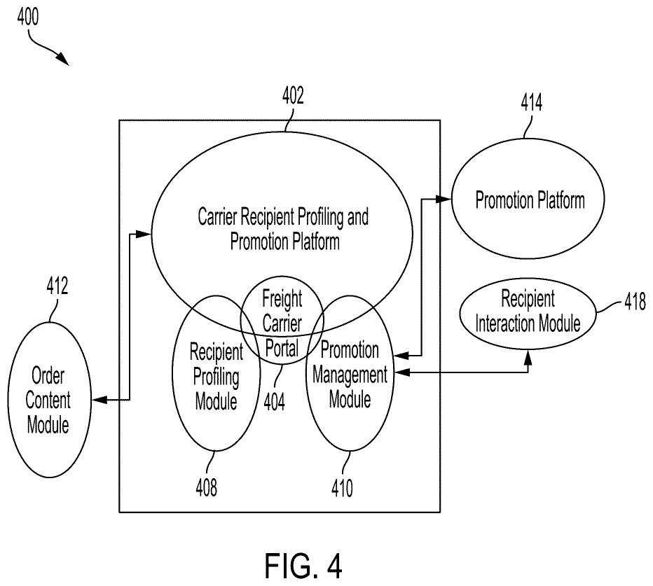

FIG. 4 illustrates a recipient order content-based demographic profiling and promotion system 400, in accordance with embodiments of the present invention. System 400 comprises a carrier recipient profiling and promotion platform 402, a freight carrier portal 404, a recipient profiling module 408, a promotion management module 410, a shipping entity module 412, a promotion platform module 414, and a recipient interaction module 418. Carrier recipient profiling and promotion platform 402 is configured to store package recipient items and execute a profile process with respect to package recipients. Likewise, carrier recipient profiling and promotion platform 402 is configured to execute program code and associated rules and track recipient responses. Freight carrier recipient profiling and promotion platform 402 provides API, data, and reporting functionality for shipping entities. Freight carrier portal 404 is configured to enable a remote portal for package recipients placing orders from multiple merchants. Recipient profiling module 408 is configured to generate profiles for package recipients based on on items received from shipping clients and package recipient address related demographics. Promotion management module 410 is configured to execute a process for matching and tracking shipped orders with respect to shipping clients enabled to generate promotions. Promotion management module 410 is further configured to process promotional bids and select promotions associated with allowed orders. Likewise, promotion management module 410 is configured to control a process for applying a promotion to a package being processed on package sorters with respect to matched promotional entities. The promotion may additionally be presented with respect to an order tracking Webpage and results may be stored in a memory structure. Shipping entity module 412 is configured to provide opt-in functionality with respect to a package order, order contents, permitted promotion provision with respect to: an electronic file API, a package recipient address and name, a package order ID, and permitted or blocked promotional entities. Promotion platform module 414 is configured to provide a platform desired recipient demographic. Recipient interaction module 418 is configured to place a promotional structure on a package and present the promotion via a Web tracking age, an SMS, an email etc.

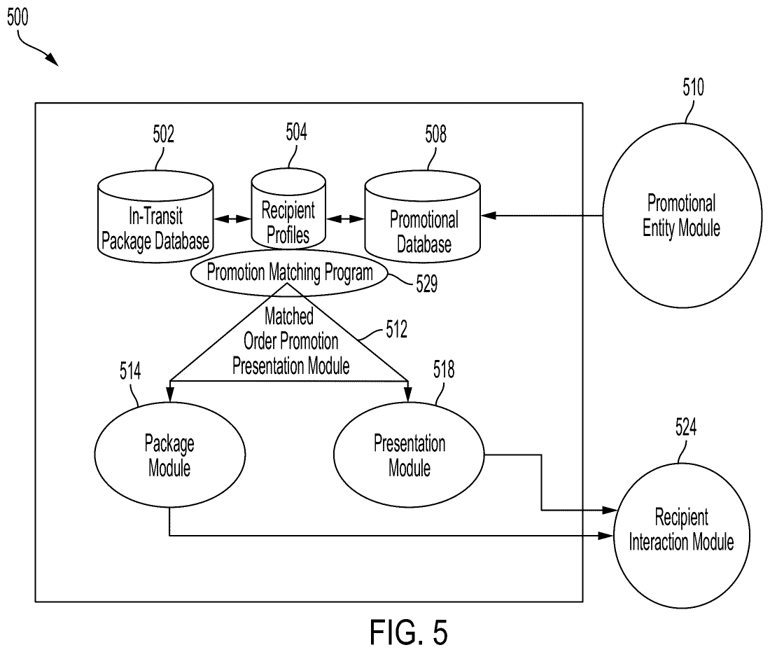

FIG. 5 illustrates a package recipient promotion generation system 500, in accordance with embodiments of the present invention. System 500 comprises an in-transit package database 502 a recipient profile database 504, a promotional database 508, promotion matching program code 529, a matched order promotion presentation module 512, a package module 514, a presentation module 518, a promotional entity module 510, and a recipient interaction module 524. In-transit package database 502 is configured to store data describing in-transit packages being shipped via a freight carrier entity. Each of the packages is associated with at least one promotional entity. Recipient profile database 504 is configured to store package recipient profiles. Promotion matching program code 529 comprises software code configured to control all functionality of system 500. Promotional database 508 is enabled for storing desired package recipient profiles, an associated quantity of packages delivered, price offers for packages, and package order time windows. Matched order promotion presentation module 512 is configured to control all functionality associated with matching promotions with package orders. Package module 514 is configured to control functionality for applying a physical promotional structure (e.g., a label such as a visible promotion or a QR code, a RFID tag etc. The physical promotional structure may be applied to the package at a specified location on the package. Package module 514 may be further configured to track a package physically to a label printer or to a QR code or RFID tag programming unit. Presentation module 518 is configured to present a specified promotion to a package recipient via, inter alia, a Web based tracking Page, a SMS, an email, etc. Promotional entity module 510 may be associated with a shipping entity. Alternatively, promotional entity module 510 may be associated with a non-shipping entity. Promotional entity module 510 is configured to provide a specified recipient demographic, a quantity of packages for delivery, a package delivery time window, a price or bid per promotion, current customer IDs, etc. Recipient interaction module 524 is configured to control and monitor package recipient interaction with physical and digital promotional structures.

Carriers utilizing carrier-related ad platforms may collaborate with other digital ad platforms such as Google®, Facebook®, Amazon®, etc. by providing recipient demographic profiles in whole or in part to the other digital ad platforms to further improve the demographic targeting of ads served on the other digital ad platforms. The recipient demographic profiles may be provided directly by the carrier or via the carrier-related ad platforms. Conversely, the carrier-related ad platforms may combine data provided by the other digital ad platforms through a common demographic profile ad ID such as email or address or device IDs used by the profile.

Carriers such as FedEx® and UPS may form a common database or submit respective recipient demographic or other recipient information to a third party database to form a unified demographic profiling database and platform which all participating carriers can share when providing recipient demographic profiles to advertisers. The unified demographic profiling database and platform includes unified demographic recipient profiles of recipients. For example, a particular unified demographic recipient profile of a particular recipient may be from data provided by multiple participating carriers and/or by vendors selling items to the particular participant. When one carrier has an in-transit parcel being sent to the particular recipient, that one carrier may use the unified demographic recipient profile of the particular recipient to present to potential advertisers.

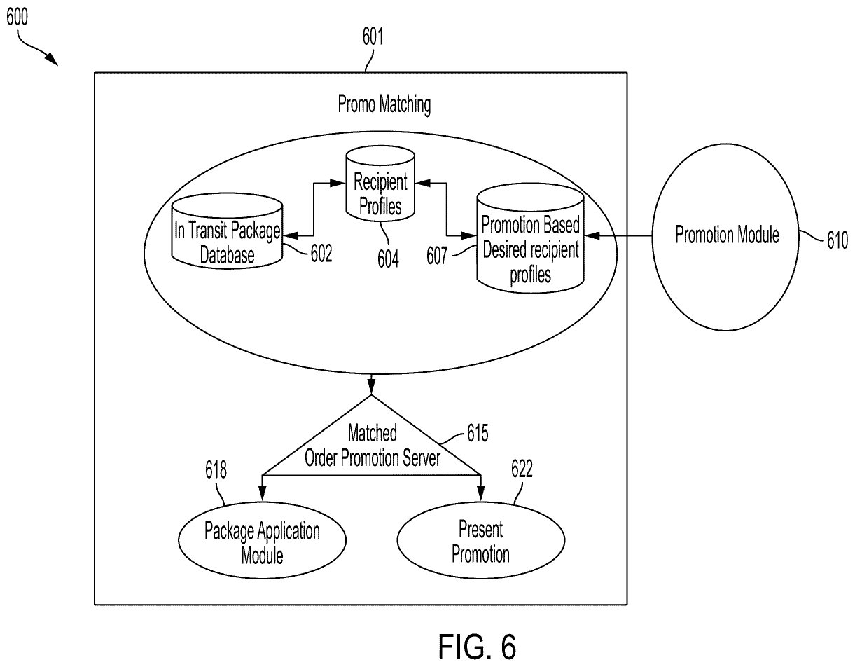

FIG. 6 illustrates a cross-referencing system 600, in accordance with embodiments of the present invention. System 600 comprises an in-transit package database 602, a recipient profile database 604, a promotional recipient database 607, a matched order promotion server module 615, a package application module 618, a presentation module 622, and a promotion module 610. In-transit package database 602 is configured to store data describing in-transit packages being shipped via a freight carrier entity. The data may include, inter alia, package identification for packages pending a freight carrier sort process, etc. Recipient profile database 604 is configured to store package recipient profiles. Promotional recipient database 607 is configured for storing desired package recipient profiles, an associated quantity of packages delivered, price offers for packages, and package order time windows. In-transit package database 602, recipient profile database 604, and promotional recipient database 607 are configured to (in combination) provide input for executing a process for matching in-transit package recipients with established recipient profiles with respect to a package delivery stage. Likewise, desired recipient profiles are matched with in-transit package recipient profiles of package recipients that are not associated with a desired promotional entity. The matching process enables a process for promotional entity bidding with respect to available matching promotional structure package placement. Matched order promotion server 615 is configured to control all functionality associated with matching promotions with package orders. Package application module 618 is configured to control functionality for applying a physical promotional structure (e.g., a label such as a visible promotion or a QR code, a RFID tag etc. The physical promotional structure may be applied to the package at a specified location on the package. Package application module 618 may be further configured to track a package physically to a label printer or a QR code or RFID tag programming unit. Presentation module 622 is configured to present a specified promotion to a package recipient via, inter alia, a Web based tracking Page, a SMS, an email, etc. Promotion module 610 may be associated with a shipping entity. Alternatively, promotion module 610 may be associated with a non-shipping entity. Promotion module 610 is configured to provide a specified recipient demographic, a quantity of packages for delivery, a package delivery time window, a price or bid per promotion, current customer IDs, etc.

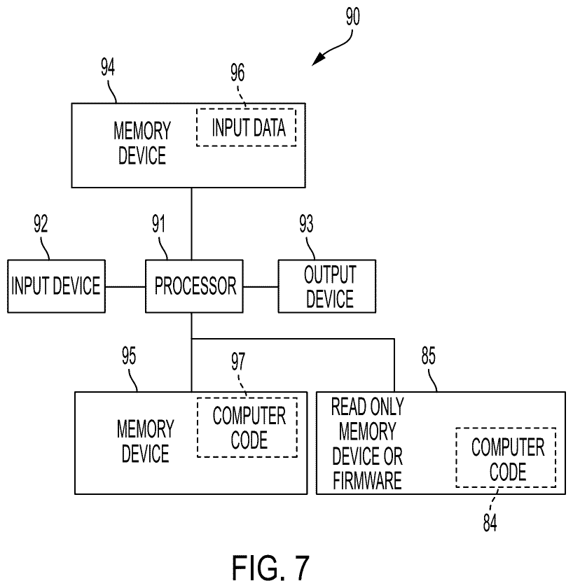

FIG. 7 illustrates a computer system 90 (e.g., freight carrier server 139, tracking system 139a, programming/application hardware 139b, shipping client systems 114, promotional entity systems 123, and/or recipient systems 119 of FIG. 1A) used by or comprised by the system 100 of FIG. 1A for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated the package for delivery or a demographic profile of a package recipient, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 7 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for improving software implemented promotional structure generation technology associated with receiving electronic data comprising shipment identification data for a shipment of an item, authorizing a shipping client associated with freight carrier to generate visible promotional structures associated with specified packages, and generating and presenting a physical or digital visible promotional structure associated the package for delivery or a demographic profile of a package recipient. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 96) may include algorithms (e.g., the algorithm of FIG. 2) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithms) may be stored on a static, nonremovable, read-only storage medium such as a Read-Only Memory (ROM) device 85, or may be accessed by processor 91 directly from such a static, nonremovable, read-only medium 85. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

### Package Tracking Platform

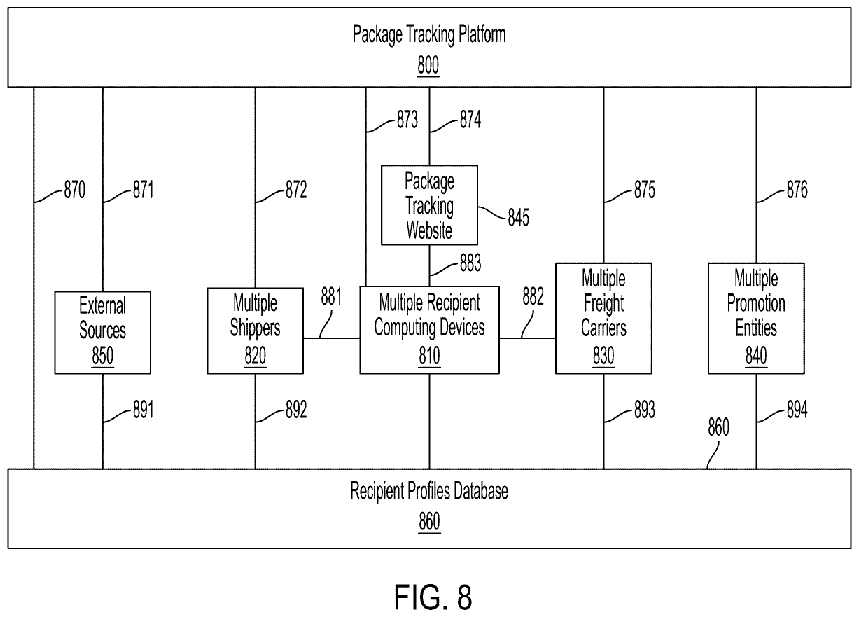

FIG. 8 illustrates a system, in accordance with embodiments of the present invention.

The system of FIG. 8 includes a package tracking platform 800, multiple recipient computing devices 810 under control of respective multiple package recipients, multiple shippers 820, multiple freight carriers 830, multiple promotion entities 840, multiple external sources 850, a recipient profiles database 860 storing recipient profiles of the multiple package recipients, and a package tracking website 845.

The package tracking platform 800 is configured to receive a request from a promotion entity of the multiple promotion entities 840 to display a promotion to a package recipient of the multiple package recipients. The package tracking platform 800 is configured to process and implement the request.

Each shipper of the multiple shippers 820, each freight carrier of the multiple freight carriers 830, each promotion entity of the multiple promotion entities 840, and each external source of the multiple external sources 850 has a computer or a computer system which may be configured, in one embodiment, in accordance with the computer system 90 of FIG. 7.

Each recipient computing device of the multiple recipient computing devices 810 is a computer which may be configured, in one embodiment, in accordance with the computer system 90 of FIG. 7. In one embodiment, the computer is a personal computer, a laptop computer, a cell phone, etc.

The package tracking platform 800 is communicatively connected to: the multiple recipient computing devices 810 via one or more communication links 873, the multiple shippers 820 via one or more communication links 872, the multiple freight carriers 830 via one or more communication links 875, the multiple promotion entities 840 via one or more communication links 876, the external sources 850 via one or more communication links 871, the recipient profiles database 860 via one or more communication links 870, and the package tracking website 845 via one or more communication links 874.

The multiple recipient computing devices 810 are communicatively connected to: the multiple shippers 890 via one or more communication links 881, the multiple freight carriers 830 via one or more communication links 882, and the package tracking website 845 via one or more communication links 883.

The package tracking platform 800 controls and manages the recipient profiles database 860 via the one or more communication links 870. The recipient profiles database 860 may be disposed within the package tracking platform 800 or located external to the package tracking platform 800.

The package tracking platform 800 controls and manages the package tracking website 845 via one or more communication links 874. The package tracking website 845 may be disposed within the package tracking platform 800 or located external to the package tracking platform 800.

In one embodiment, the package tracking platform 800 may permit one or more external sources of: the external sources 850, the multiple shippers 820, the multiple freight carriers 830, and the multiple promotion entities 840 to conditionally access the recipient profiles database 860 via one or more communication links 891, 892, 893, and 894, respectively (e.g., to generate or update one or more recipient profiles in the recipient profiles database 860). The one or more communication links 891, 892, 893, and 894 may not exist in other embodiments of the present invention.

Each communication link of the one or more communication links 870-876, 881-883, and 891-894 between entities may be any known communication link that enables communication between the entities, including, inter alia, physical links, virtual links (e.g., via the Internet), telecommunication links (e.g., via communication satellites), etc.

A customer orders a product from a first shipper of the multiple shippers 890. The first shipper ships a first package containing the product to the customer via a first freight carrier of the multiple freight carriers 830. After receiving the first package delivered by the first freight carrier, the customer may return the product to the first shipper (e.g., for a refund of the customer's payment for the product) via a second freight carrier of the multiple freight carriers 830 if the customer satisfies criteria set by the first shipper for returning the product. The customer is a package recipient of the multiple package recipients who control the multiple recipient computing devices 810.

The package tracking platform 800 tracks, for the customer, the order (from shipment of the first package by the first shipper to delivery of the first package to the customer by the first freight carrier). In one embodiment, the tracking of the order by the package tracking platform 800 is facilitated by the package tracking platform 800 obtaining a tracking number of the order from the first shipper, wherein the tracking number enables the package tracking platform 800 to track the order on a website of the first freight carrier or on a website of the first shipper.

The package tracking platform 800 also tracks, for the customer, return of the product (from shipment of a second package containing the product by the customer to delivery of the second package to the first shipper by the second freight carrier). The tracking of the return by the customer is facilitated by the package tracking platform 800 obtaining of a tracking number of the return from the first shipper, wherein the tracking number enables the package tracking platform 800 to track the order on a website of the second freight carrier or on a website of the first shipper.

The first freight carrier and the second freight carrier may be a same freight carrier or a different freight carrier. The first package containing the product and the second package containing the product may be a same package containing the product or a different package containing the product.

The package tracking platform 800 provides a tracking status of the shipment from the customer, and a tracking status of the return of the product by the customer, at the package tracking website 845 to which the customer may be linked via the one or more communication links 883.

In one embodiment, the package tracking website 845 is not owned or controlled by any of: the first shipper, the first freight carrier, and the second freight carrier.

In one embodiment, the package tracking website 845 is owned or controlled by the package tracking platform 800.

In one embodiment, the package tracking website is owned or controlled by any of: the first shipper, the first freight carrier, and the second freight carrier.

In one embodiment, the package tracking website is owned or controlled by a promotion entity of the multiple promotion entities 840, an external source of the external sources 850, a shipper of the multiple shippers 820, or a freight carrier of the multiple freight carriers 830.

In one embodiment, the package tracking website is not owned or controlled by the package tracking platform 800 and is owned by another platform that permits the package tracking website to perform the displaying of the promotion to each selected package recipient who is currently linked to the package tracking webpage.

The customer may initiate a process of linking to the package tracking website 845. Alternatively, the customer may link to the package tracking website 845 as a result of being invited, by a communication from the package tracking platform 800 (e.g., email, Short Message Service (SMS), etc.) to link to the package tracking website 845.

Once the customer is linked to the package tracking website 845, the package tracking platform 800 may display a promotion (e.g., an advertisement) for a product or service promoted by a first promotion entity of the multiple promotion entities 840. The promotion may be displayed to the customer while the product is being shipped to the customer or while the product is being returned by the customer.

Each promotion entity of the multiple promotion entities 840 may provide the promoted product or service or may represent an other entity that provides the promoted product or service. In one embodiment, the other entity that provides the promoted product or service may be, inter alia, one shipper of the multiple shippers 890, one freight carrier of the multiple freight carriers 830, the package tracking platform 800, another package recipient of the multiple package recipients who control and manage the multiple recipient computing devices 810, or any other entity. In one embodiment, the other entity that provides the promoted product or service is not: the package tracking platform 800, any shipper of the multiple shippers 890, any freight carrier of the multiple freight carriers 830, any promotion entity of the multiple promotion entities 840, or any package recipient of the multiple package recipients who control and manage the multiple recipient computing devices 810.

In one embodiment, the display of the promotion is initiated by the first promotion entity who transmits a request and recipient criteria to the package tracking platform 800 to display the promotion to one or more customers whose respective recipient profiles in the recipient profiles database 860 satisfy the recipient criteria. In one embodiment, the recipient criteria limits the display of the promotion to the customer at the package tracking website 845 to only while the product is being shipped to the customer or only while the product is being returned by the customer.

The package tracking website 845 may be configured to have a look and feel of a webpage at a website of the first shipper, the first freight carrier, or the second freight carrier.

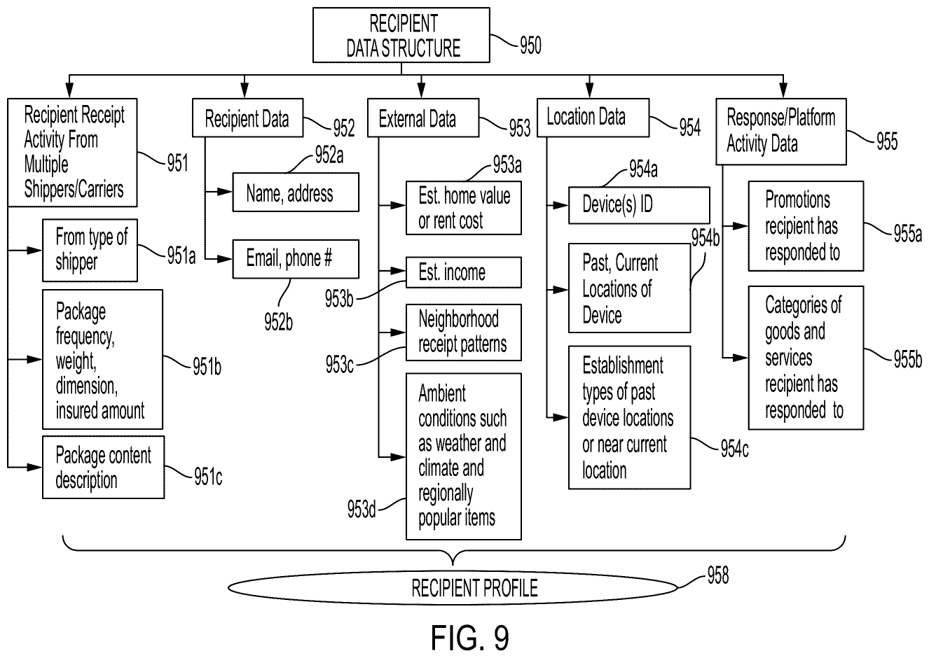

Each recipient profile in the recipient profiles database 860 is a data structure, a portion of which may be configured in accordance with FIG. 9.

FIG. 9 illustrates a partial view of a recipient profile 958 in the recipient profiles database 860 in the system of FIG. 8, in accordance with embodiments of the present invention.

The recipient profile 958 is depicted in FIG. 9 as a recipient data structure 950 whose organization of data in FIG. 9 is illustrative; i.e., any other organization of data may be used for the data structure of each recipient profile 958 in the recipient profiles database 860 in the system of FIG. 8.

The recipient profile 958 is organized into data categories of package recipient receipt activity data 951, recipient data 952, external data 953, location data 954, and response/platform activity data 955.

Recipient receipt activity 951 from the multiple shippers/carriers, which may be received from the multiple shippers/carriers, pertains to orders of goods currently or previously shipped to the package recipient and/or currently or previously returned by the package recipient. The recipient receipt activity 951 may include, for each order recorded in the recipient receipt activity 951, inter alia, the following data items: identification and type of shipper from which the package originated 951a; package frequency (of being sent), package weight, package dimensions, and insured amount of package content 951b; and package content description data associated with the package shipments (e.g., description of package content; shipment identification data for the package shipments) 951c. The package content description data 951c may also include, a tracking number of the shipped and/or returned package, a bar code structure, a universal product number (UPC) structure, stock keeping unit (SKU) code structure, a radio frequency identification (RFID) structure, an order number, and a package status having a value of BEGIN, SHIP, RETURN, or RECEIVED currently.

The package status value of BEGIN is defined as denoting that an order has been initiated for shipping a package of goods to the package recipient but shipping of the package of goods to the package recipient has not yet been initiated.

The package status value of SHIP is defined as denoting that the package of goods has been shipped to the package recipient by a first shipper of the multiple shippers 820 via a first freight carrier of multiple the freight carriers 830 but has yet not been received by the package recipient and is being tracked, in real time by the package tracking platform 800 until the package of goods is received by the package recipient.

The package status value of RETURN is defined as denoting that the package recipient has received the package of goods from the first shipper and the package of goods is currently being returned to the first shipper by the package recipient via a second freight carrier of the multiple freight carriers 830 and is being tracked, in real time by the package tracking platform 800, until the package of goods is returned to the first shipper.

The package status value of RECEIVED is defined as denoting that the package recipient has received the package of goods from the first shipper and the package recipient has not initiated a return of a package of the goods to the first shipper. In one embodiment for which the package status value is RECEIVED, the package recipient is currently entitled to return the package to the first shipper. In one embodiment for which the status parameter value is RECEIVED, the package recipient is currently not entitled to return the package to the first shipper (e.g., the current date is later than the latest date for returning the package to the first shipper).

An order may be active or inactive. By definition, an order is active if the package status value is SHIP or RETURN. By definition, an order is inactive if the package status value is BEGIN or RECEIVED.

The package status value of BEGIN, SHIP, RETURN, and RECEIVED is illustrative text that may be replaced by any other text defined to have a same meaning as BEGIN, SHIP, RETURN, and RECEIVED, respectively.

The receipt activity 951 which may be received by the package tacking platform 800 from the multiple shippers 820 and/or the multiple freight carriers 830 and/or an other platform. The other platform may scrape, upon permission from the package recipient, the package recipient's email for incoming orders and interrogate the multiple freight carriers 830 for package status updates.

Recipient data 952, which may be received from, inter alia, the multiple shippers 820 and/or the multiple freight carriers 830 carriers, may include, inter alia, the following data items: name and address of package recipient 952a; and email address and phone number (landline or cell phone) of recipient 952b.

External data 953, which may be received from, inter alia, the external sources 850, may include, inter alia, the following data items: estimated home value or rental cost 953a; estimated income 953b; neighborhood receipt patterns 953c; and ambient conditions such as weather, climate, and regionally popular items 953d.

Location data 954, which may be obtained from, inter alia, a telecommunication service provider (e.g., a provider of telephone and/or cell phone services), may include, inter alia, the following data items: an identification (ID) of one or more user device(s) 954a; past and/or current locations of device 954b, and establishment types of past device locations or near past and/or current locations 954c. In one embodiment, the one or more user device(s) 954a includes one or more mobile devices. In one embodiment, the external sources 850 may include the telecommunication service provider.

In one embodiment if the device is a mobile device, the current locations of device 954b may be tracked via cell towers and/or a telephone company may provide continuous time data, periodic time data, or specific discrete data about the mobile device and/or the package recipient.

Response/platform activity data 955, which may be obtained from, inter alia, the multiple promotion entities 840 and/or the package tracking platform 800 (from previous shipping and/or returning of packages tracked by the package tracking platform 800), may include, inter alia, data items of: promotions (e.g., advertisements) that the package recipient has responded to 955a and categories of goods and services that the package recipient has responded to (e.g., via shopping and/or purchasing) 955b, and any data in the recipient data structure 950 that is associated with each promotion that the package recipient has responded to (e.g., such data as the estimated value of the package recipient's home 953a at a time when the package recipient responded to the promotion).

The promotions that the package recipient has responded to 955a may include positive responses, negative responses, and neutral responses. A positive response is a purchase by the package recipient of the product being promoted in the promotion. A negative response is no response by the package recipient to the promotion. A neutral response is a query by the package recipient about the product being promoted (e.g., linking by the package recipient to a website link within the promotion presented to the package recipient) that does not result in a purchase of the product by the package recipient.

The categories of goods and services that the package recipient has responded to 955b may include any category of goods and services such as, inter alia, shoes, women's clothing, dental services, etc.

Other items that may be included within response/platform activity data 955 are, inter alia, identity of the promoter of the promotion, visual characteristics of the promotion (e.g., color, text style, background scenery, geometrical shapes, etc.), links to additional information, etc.).

Since FIG. 9 is only a partial view of data categories and data, the data categories and data of recipient profile 958 in the recipient data structure 950 are not limited to the data categories and data depicted in FIG. 9.

For example, the recipient profile 958 in the recipient data structure 950 may be augmented by data obtained via demographic profiling technologies such as cookies, web beacons, and similar technologies. Cookies are information passed between each user's browser and a web server to enable websites to identify particular users. Web beacons are small graphic data, also known as clear GIFs, that recognize user activity, such as if and how often a user has visited a website. A GIF (Graphics Interchange Format) is a picture file that is used on the Internet. Cookies save the history of a user's browsing activity on the user's computer at the request of a web server, which allows the web server to recognize each user's browser as an identifier (ID) and to store information about the user's activity at websites, such as the number of visits, and the dates and times. When browsing a website again, the user's computer sends the cookie information to the web server, which identifies the user's browser by verifying the cookie information, which is how the web server is able to identify each user's access trends. Cookies, however, do not identify a user's private information, so a cookie is best described as a browser-specific identifier (ID) that automatically generates a series of numbers and letters that cannot be used for individual identification. Web beacons are tools used to track a user's Internet journey for specific websites and have also been referred to as web bugs, clear GIFs, tracking pixels, spy pixels, and pixel tags. A website typically employs web beacons to count users or see how pages on the website have been accessed. Unlike tracking cookies which a user can decline, a user cannot decline web beacons. Web beacon are files that monitor activity of a user on a website to build analytical reports. Web beacons are used to track user behavior, such as content the user interacts with (e.g., emails opened by the user). Web beacons work similarly to Internet cookies. A graphic image or a HyperText Markup Language (HTML) element loads from an external source to a web page, which is not visible to the human eye and thus will not interfere with the user's Internet browsing. A web beacon is sometimes known as a spy pixel because the web beacon is sufficiently small to be nearly invisible. The embedded coding in a web beacon may be used for tracking user activity for specific websites. When a webpage is opened on a website, the web beacon's web server receives a request, and the code is sent, or a clear image is uploaded to, the user's device or is sent to the user in an email message. Then the web beacon file tracks how the user navigates via online browsing, which is very similar to spyware, but much less intrusive. Email beacons work the same way. Email beacons are also invisible images that are placed inside the email body without interrupting the email communications. Email marketing companies desire information as to whether the user has opened the emails sent to the user by the email marketing companies, and the email web beacons will deliver such information. The email web beacons will also let these email marketing companies know when the user opened the mail and can get the user's Internet Protocol (IP) address. Technology services pertaining to cookies, web beacons, and similar technologies may be provided to the webpage server by third parties such as ad brokers, and data resulting use of such technology services may be included in recipient profile 958 in the recipient data structure 950 and may also be linked to an email address of carriers and after-shipment platforms. Thus, a tracking number entered on a package tracking webpage can be linked to: (i) an email address and data associated with that email address; (ii) data associated with cookies and beacons; and (iii) data provided by ad brokers and related services. Thus, augmenting the recipient profile 958 in the recipient data structure 950 with the preceding profiling technologies (i.e., cookies, web beacons, and similar technologies) may facilitate more precise selection of package recipients to whom promotions may be displayed. Success rates of such promotions may likewise be analyzed (e.g., by artificial intelligence (AI) models) to determine if such augmented recipient profiles result in higher conversion rates for such promotions, and under what conditions, than do recipient profiles lacking such augmentation.

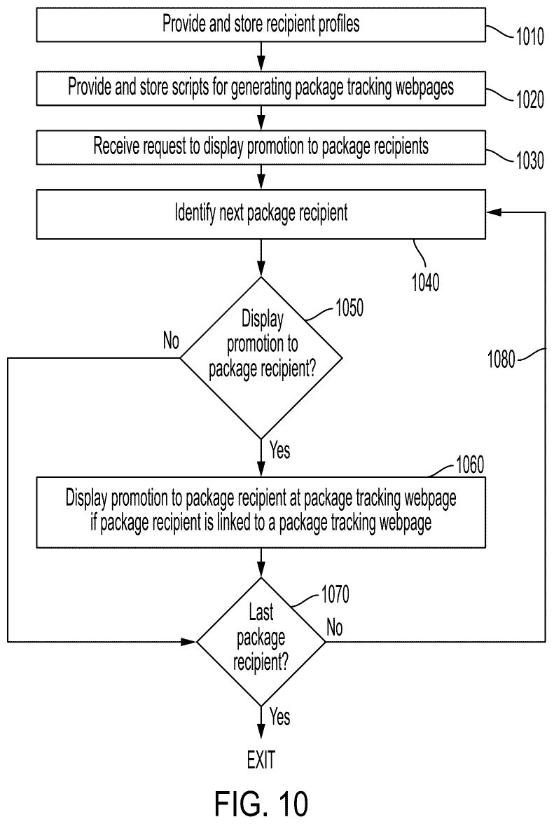

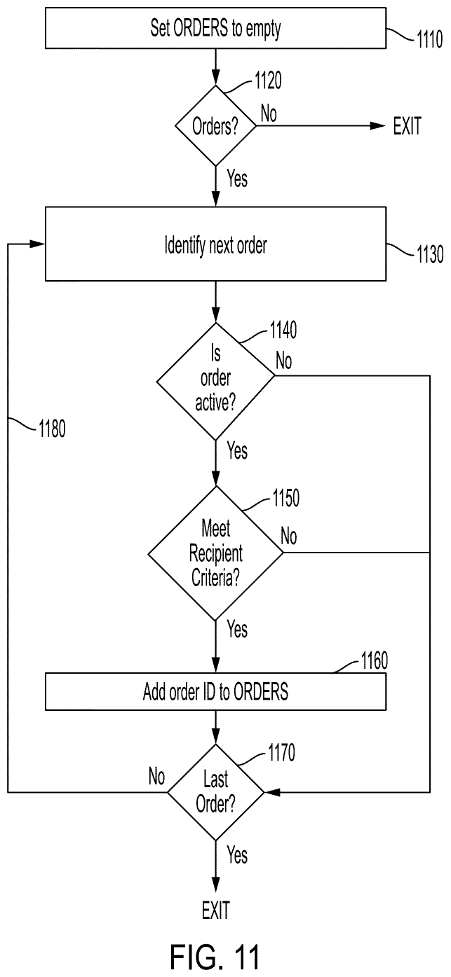

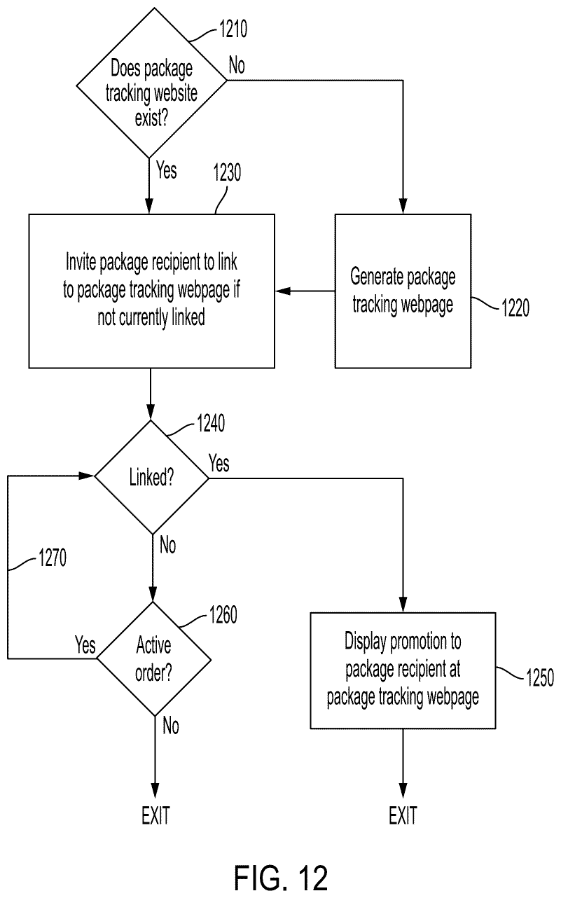

FIG. 10 is a flow chart of a first embodiment of a method of displaying a promotion to package recipients linked to webpages, in accordance with embodiments of the present invention. FIGS. 11-12 provide embodiments for implementing steps performed in the method of FIG. 10.

The flow chart of FIG. 10 includes steps 1010-1070.

In step 1010, the recipient profiles of the multiple recipients are provided and stored in the recipient profiles database 860.

In one embodiment, the package tracking platform 800 provides the recipient profiles by generating the recipient profiles, using data received by the package tracking platform 800 from various sources including, inter alia, one or more of: the multiple shippers 820, the multiple freight carriers 830, the external sources 850, the multiple promotion entities 840, and the multiple package recipients. After and/or during generation of the recipient profiles, the package tracking platform 800 stores the recipient profiles in the recipient profiles database 860.

In one embodiment, an external entity (e.g., an external computer system) that is external to the system of FIG. 8 generates the recipient profiles, using data received by the package tracking platform 800 from the preceding various sources, after which the external entity provides the generated recipient profiles to the package tracking platform 800. After receiving the generated recipient profiles from the external entity, the package tracking platform 800 stores the recipient profiles in the recipient profiles database 860.

In one embodiment, the preceding external entity generates the recipient profiles, using data received by the package tracking platform 800 from the preceding various sources. After and/or during generation of the recipient profiles, the external entity, with permission of the package tracking platform 800, stores the recipient profiles in the recipient profiles database 860.

In one embodiment, the recipient profile of each package recipient of the multiple package recipients may be dynamically updated by being modified by an addition of, a deletion of, or a change in one or more parameters in the recipient profile.

In step 1020, the package tracking platform 800 stores, in a data store of the package tracking platform 800, scripts for generating package tracking webpages. Any known script language (e.g., HyperText Markup Language (HTML)) for generating websites and webpages may be used for generating package tracking webpages. The scripts may be generated by the package tracking platform 800 or by one entity the provides the scripts to the package tracking platform 800. The package tracking website, which may be generated by executing the scripts, may be used to provide package tracking information to package recipients and to display promotions to package recipients who are linked to the package tracking webpages, as described infra.

In one embodiment, step 1020 generates the package tracking webpages, using the scripts.

In step 1030, the package tracking platform 800 receives a request to display a promotion to package recipients of the multiple package recipients. In one embodiment, the package tracking platform 800 receives the request from a promotion entity of the multiple promotion entities 840. The request includes specification of the promotion and recipient criteria for identifying package recipients to which the promotion may be displayed. Such recipient criteria may include parameters that can be cross referenced against parameters of package recipients in the recipient profiles in the profiles database 860 to identify package recipients who are candidates for receiving a display of the promotion.

For example, the recipient criteria may include one or more of: package recipient has an estimated income (annual income, monthly income, etc.) of at least a specified minimum income; package recipient has not previously purchased anything from a specified promotion entity; package recipient's residence is in a specified geographical area; package recipient resides in a neighborhood or community in which certain goods (e.g., sporting goods, cosmetics, garden products) are currently popular; package recipient resides in a cold climate with respect to cold weather clothing being promoted in the promotion; package recipient has previously purchased, from a specified promotion entity, an item that is substantially similar to an item being promoted in the promotion; etc.

Steps 1040-1070 are an iteration of a loop 1080 over the multiple package recipients whose recipient profiles are stored in the recipient profiles database 860. Each iteration of the loop 1080 is specific to a different package recipient.

In step 1040, the package tracking platform 800 identifies a next package recipient of the multiple package recipients to be processed in the current iteration of the loop 1080. Step 1040 may use any manner (e.g., random selection) to identify the next package recipient for the current iteration.

In step 1050, the package tracking platform 800 determines whether to display the promotion to the package recipient. If so (Yes branch from step 1050) then step 1060 is next executed. If not (No branch from step 1050) then step 1070 is next executed. FIG. 11 presents an embodiment for implementing step 1050.

In step 1060, the package tracking platform 800 displays the promotion to the package recipient at a package tracking webpage if the package recipient is linked to the package tracking webpage, followed by execution of step 1070. FIG. 12 presents an embodiment for implementing step 1060.

In step 1070, the package tracking platform 800 determines whether the package recipient in the current iteration of the loop 1080 is the last package recipient to be processed. If so (Yes branch from step 1070) then the method exits (i.e., ends). If not (No branch from step 1070) then the method loops back to step 1040 to identify the next package recipient to process in the next iteration of the loop 1080.

FIG. 11 is a flow chart of a process that implements step 1050 (determining whether to display the promotion to the package recipient) of FIG. 10, in accordance with embodiments of the present invention. The process of FIG. 11 is performed with respect to the package recipient that is specific to the current iteration in loop 1080 of FIG. 10.

The flow chart of FIG. 11 includes steps 1110-1170.

In step 1110, the package tracking platform 800 sets a parameter ORDERS to empty (i.e., ORDERS exists with no included data). The process of FIG. 11 fills the parameter ORDERS with order identifiers (order IDs) of active orders of the package recipient if such active orders exist.

By definition, an order is active if the package of the order has a package status value SHIP (i.e., a SHIP status of currently being shipped to the package recipient via a first freight carrier) or RETURN (i.e., a RETURN status of currently being returned from the package recipient to the shipper via a second freight carrier.

In step 1120, the package tracking platform 800 determines whether there are any past or present orders recorded in the package recipient's recipient profile 958 in the recipient profiles database 860 for the package recipient. If so (Yes branch from step 1120) then step 1130 is next executed. If not (No branch from step 1120) then the process exits (i.e., ends).

Steps 1130-1170 are an iteration of a loop 1180 over the past and present orders of the package recipient. Each iteration of the loop 1180 is specific to a different order of the package recipient.

In step 1130, the package tracking platform 800 identifies the next order of the package recipient in the package recipient's recipient profile 958 in the recipient profiles database 860. Step 1130 may use any manner (e.g., random selection) to identify the next order for the current iteration.

In step 1140, the package tracking platform 800 determines whether the order is active. If so (Yes branch from step 1140) then step 1150 is next executed. If not (No branch from step 1140) then step 1170 is next executed.

In step 1150, the package tracking platform 800 determines whether the package recipient meets the recipient criteria specified in the request to display the promotion, where the request is received in step 1030 of FIG. 10. If so (Yes branch from step 1150) then step 1160 is next executed. If not (No branch from step 1150) then step 1170 is next executed. In one embodiment, step 1150 is implemented by cross referencing, by the package tracking platform 800, the package recipient's recipient profile 958 in the recipient profiles database 860 with the recipient criteria specified in the request to display the promotion.

Although FIG. 11 depicts step 1150 being executed after step 1140 is executed, step 1150 may alternatively be executed before step 1140 is executed.

In step 1160, the package tracking platform 800 adds the order identifier (ID) to the parameter ORDERS.

In step 1170, the package tracking platform 800 determines whether the order identified for the current iteration is the last order of the package recipient in the package recipient's recipient profile 958 in the recipient profiles database 860. If so (Yes branch from step 1170) then the method exits (i.e., ends). If not (No branch from step 1170) then the method loops back to step 1130 to identify the next order to process in the next iteration of the loop 1180.

An output of the process of FIG. 11 is the ORDERS parameter. If ORDERS is empty then the promotion is not to be displayed to the package recipient, which activates the No branch from step 1050 of FIG. 10. If Orders is not empty (i.e., ORDERS contains one or more order IDs) then the promotion may be displayed to the package recipient in accordance with step 1060 of FIG. 10. If ORDERS contains two or more order IDs, then one of the order IDs may be selected by any process (e.g., random selection) to identify a specific order to be used for further processing.

FIG. 12 is a flow chart of a process that implements step 1060 (displaying the promotion to the package recipient at a package tracking webpage if the package recipient is linked to a package tracking webpage) of FIG. 10, in accordance with embodiments of the present invention. The process of FIG. 12 is performed with respect to the package recipient that is specific to the current iteration in loop 1080 of FIG. 10.

The flow chart of FIG. 12 includes steps 1210-1260.

In step 1210, the package tracking platform 800 determines whether the package tracking website exists for the package recipient. If so (Yes branch from step 1210) then step 1230 is next executed. If not (No branch from step 1210) then step 1220 is next executed. A reason why the package tracking website may exist is that the package tracking website was previously generated in step 1020 of FIG. 10.

In step 1220, the package tracking platform 800 generates the package tracking website for the package recipient, after which step 1230 is next executed. In one embodiment, the package tracking website 845 is generated using the scripts provided in step 1020 of FIG. 10.

In step 1230 if the package recipient is not currently linked to the package tracking web page, the package tracking platform 800 invites the package recipient to link to the package tracking webpage 845.

In one embodiment, step 1230 is implemented by sending an electronic communication (e.g., email, Short Message Service (SMS), etc.) to the package recipient, wherein the electronic communication includes a link to the package tracking webpage, and wherein the electronic communication invites the package recipient to activate the link to the package tracking webpage.

In step 1240, the package tracking platform 800 determines whether the package recipient is linked to the package tracking web page. If so (Yes branch from step 1240) then step 1250 is next executed. If not (No branch from step 1240) then step 1260 is next executed.

In step 1250, the package tracking platform 800 displays the promotion to the package recipient at the package tracking webpage 845, after which the process is exited (i.e., ends). In one embodiment the promotion is displayed to the package recipient on a display screen of a computing devices 810 (e.g., a personal computer, a laptop computer, a cell phone, etc.)

In step 1260, the package tracking platform 800 determines whether there is an active order for the package recipient. If so (Yes branch from step 1260) then processing branches back to step 1240 is again determine whether the package recipient is linked to the package tracking web page. If not (No branch from step 1260) then the process is exited (i.e., ends).

As discussed supra, by definition, an order is active if the package of the order has a package status value SHIP (i.e., a SHIP status of currently being shipped to the package recipient via a first freight carrier) or RETURN (i.e., a RETURN status of currently being returned from the package recipient to the shipper via a second freight carrier.

Steps 1240 and 1260 in combination constitute an iteration of a loop 1270. In one embodiment the loop 1270 is for a scenario in which the user does not accept, or waits to accept, the invitation in step 1230 to link to the package tracking webpage. Since the promotion is to be displayed to the package recipient in step 1250 only if the order is active, the invitation is effectively withdrawn (i.e., the package recipient can no longer receive a display of the promotion in step 1250) in response to the order no longer being active in accordance with the No branch from step 1260.

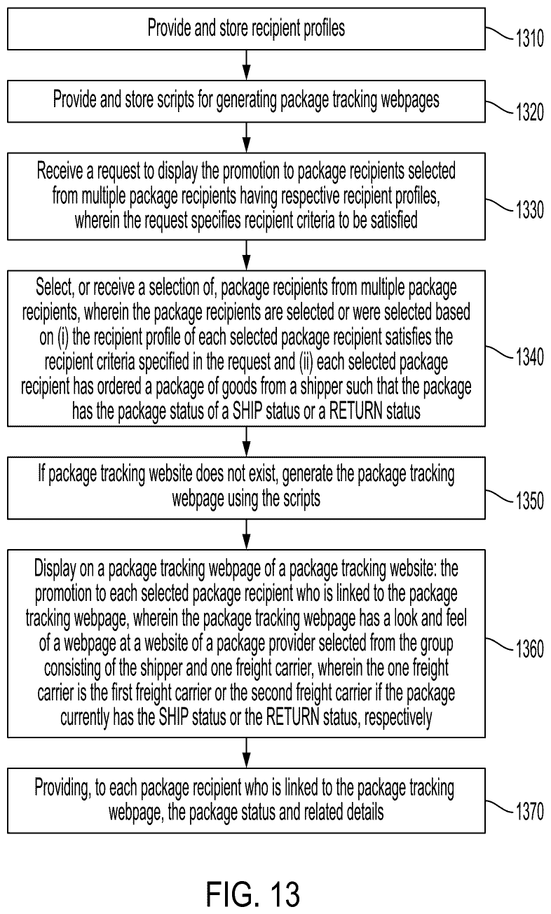

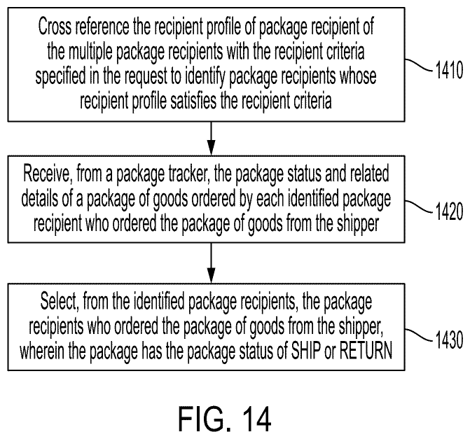

FIG. 13 is a flow chart of a second embodiment of a method of displaying a promotion to package recipients linked to webpages, in accordance with embodiments of the present invention. FIG. 14 provides an embodiment for implementing a step in the method of FIG. 13.

The second embodiment of the method of FIG. 13 may include any aspect of the first embodiment of the method of FIG. 10 that is consistent with the second embodiment of the method of FIG. 13, and vice versa.

The flow chart of FIG. 13 includes steps 1310-1370.

In step 1310, the recipient profiles of the multiple recipients are provided and stored in the recipient profiles database 860.

In one embodiment, the package tracking platform 800 provides the recipient profiles by generating the recipient profiles, using data received by the package tracking platform 800 from various sources including, inter alia, one or more of: the multiple shippers 820, the multiple shippers 820, the multiple freight carriers 830, the external sources 850, the multiple promotion entities 840, and the multiple package recipients. After and/or during generation of the recipient profiles, the package tracking platform 800 stores the recipient profiles in the recipient profiles database 860.

In one embodiment, an external entity (e.g., an external computer system) that is external to the system of FIG. 8 generates the recipient profiles, using data received by the package tracking platform 800 from the preceding various sources, after which the external entity provides the generated recipient profiles to the package tracking platform 800. After receiving the generated recipient profiles from the external entity, the package tracking platform 800 stores the recipient profiles in the recipient profiles database 860.

In one embodiment, the preceding external entity generates the recipient profiles, using data received by the package tracking platform 800 from the preceding various sources. After and/or during generation of the recipient profiles, the external entity, with permission of the package tracking platform 800, stores the recipient profiles in the recipient profiles database 860.

In one embodiment, the recipient profile of each package recipient of the multiple package recipients may be dynamically updated by being modified by an addition of, a deletion of, or a change in one or more parameters in the recipient profile.

In step 1320, the package tracking platform 800 stores, in a data store of the package tracking platform 800, scripts for generating package tracking webpages. Any known script language (e.g., HyperText Markup Language (HTML)) for generating websites and webpages may be used for generating package tracking webpages. The scripts may be generated by the package tracking platform 800 or by one entity the provides the scripts to the package tracking platform 800. The package tracking website, which may be generated by executing the scripts, may be used to provide package tracking information to package recipients and to display promotions to package recipients who are linked to the package tracking webpages.

In one embodiment, step 1320 additionally generates the package tracking webpages, using the scripts.

In step 1330, the package tracking platform 800 receives a request to display the promotion to package recipients selected from multiple package recipients having respective recipient profiles, wherein the request specifies recipient criteria to be satisfied. The package tracking platform 800 may receive the request from a promotion entity of the multiple promotion entities 840, an external source of the external sources 850, a shipper of the multiple shippers 820, or a freight carrier of the multiple freight carriers 830.

The recipient profiles may be generated by the package tracking platform 800, one or more promotion entities of the multiple promotion entities 840, one or more external sources of the external sources 850, one or more shippers of the multiple shippers 820, one or more freight carriers of the multiple freight carriers 830 or combinations thereof.

In step 1340, the package tracking platform 800 selects, or receives a selection of, package recipients from multiple package recipients. The package recipients may be selected by the package tracking platform 800, a promotion entity of the multiple promotion entities 840, an external source of the external sources 850, a shipper of the multiple shippers 820, or a freight carrier of the multiple freight carriers 830.

The package recipients are selected or were selected based on: (i) the recipient profile of each selected package recipient satisfies the recipient criteria specified in the request and (ii) each selected package recipient has ordered a package of good from a shipper of the multiple shippers 820 such that the package has the package status of a SHIP status of currently being shipped to the package recipient via a first freight carrier of the multiple freight carriers 830 or a RETURN status of currently being returned from the package recipient to the shipper via a second freight carrier of the multiple freight carriers 830. FIG. 14 presents an embodiment for implementing step 1340.

In one embodiment, a total number of the selected package participants is at least a specified minimum number of package recipients and does not exceed a specified maximum number of package recipients.

In step 1350, the package tracking platform 800 generates the package tracking website for the package recipient if the package tracking website does not exist. In one embodiment, the package tracking website 845 is generated using the scripts provided in step 1310. In one embodiment, the package tracking website 845 was generated in step 1320 and therefore exists.

In step 1360, the package tracking platform 800 displays on a package tracking webpage of a package tracking website: the promotion to each selected package recipient who is linked to the package tracking webpage, wherein the package tracking webpage has a look and feel of a webpage at a website of a package provider selected from the group consisting of the shipper and one freight carrier, wherein the one freight carrier is the first freight carrier or the second freight carrier if the package currently has the SHIP status or the RETURN status, respectively.

In one embodiment, the request received in step 1030 limits displaying of the promotion to only package recipients whose package has the package status of the SHIP status.

In one embodiment, the request received in step 1030 limits displaying of the promotion to only package recipients whose package has the package status of the RETURN status.

In one embodiment, the package tracking platform 800 sends, to one or more of the package recipients, an email containing the status of the package and embeds the promotion in the email.

In step 1370, the package tracking platform 800 provides, to each package recipient who is linked to the package tracking webpage, the package status and related details. The related details may include, inter alia, expected date of delivery of the package, current location of the package etc.

FIG. 14 is a flow chart of a process that implements step 1340 (selection of package recipients) of FIG. 13, in accordance with embodiments of the present invention.

The flow chart of FIG. 14 includes steps 1410-1430.

In step 1410, the package tracking platform 800 cross references the recipient profile of each package recipient of the multiple package recipients with the recipient criteria specified in the request to identify package recipients whose recipient profile satisfies the recipient criteria.

In step 1420, the package tracking platform 800 receives, from a package tracker, the package status and related details of a package of goods ordered by each identified package recipient who ordered the package of goods from the shipper. In one embodiment, the package tracker is the package provider (i.e., the shipper or the one freight carrier).

In step 1430, the package tracking platform 800 selects, from the identified package recipients, the package recipients who ordered the package of goods from the shipper, wherein the package has the package status of SHIP or RETURN.

After-purchase platforms, such as AfterShip® and Narvar®, provide services for tracking shipment and delivery of packages containing items that have been purchased. However, such after-purchase platforms do not provide capabilities and functionalities of the package tracking platform 800.

In embodiments, the package tracking platform may train artificial intelligence (AI) models to predict recipient shipment types and engagement with promotions against factors such as what order history and/or promotion response activity correlates with package recipients receiving one or more subscriptions boxes, beauty orders, etc.

The AI model may predict recipient behavior based on associations among received packages, types of companies (e.g., shippers) shipping the packages (e.g. beauty, fitness), frequency or share of purchase activity by category of goods, content categories and value of goods purchased, and recipient behavior with respect to promotions and promotion attributes presented to the package recipient and with respect to purchase activity of the package recipient.

Historical data may be used to train such AI models while leaving some more recent purchase history to compare to the predictions made based on prior history. Thus, the more recent purchase history can be used to validate the AI model predictions relating to package recipient behavior.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for displaying a promotion to package recipients linked to webpages, said method comprising:
receiving, by a package tracking platform, a request to display the promotion to package recipients selected from multiple package recipients having respective recipient profiles, wherein the request specifies recipient criteria to be satisfied;
selecting, or receiving a selection of, by the package tracking platform, package recipients from multiple package recipients, said package recipients being selected, or having been selected, based on (i) the recipient profile of each selected package recipient satisfying the recipient criteria specified in the request and (ii) each selected package recipient having ordered a package of good from a shipper such that the package has the package status of a SHIP status of currently being shipped to the package recipient via a first freight carrier or a RETURN status of currently being returned from the package recipient to the shipper via a second freight carrier; and
displaying, by the package tracking platform on a package tracking webpage of a package tracking website, the promotion to each selected package recipient who is linked to the package tracking webpage, wherein the package tracking webpage has a look and feel of a webpage at a website of a package provider selected from the group consisting of the shipper and one freight carrier, wherein the one freight carrier is the first freight carrier or the second freight carrier if the package currently has the SHIP status or the RETURN status, respectively,
wherein the package tracking website is not owned or controlled by the package provider.

2. The method of claim 1, wherein said selecting the package recipients comprises:
cross referencing, by the package tracking platform, the recipient profile of each package recipient of the multiple package recipients with the recipient criteria specified in the request to identify package recipients whose recipient profile satisfies the recipient criteria; and
receiving, by the package tracking platform from a package tracker, the package status and related details of a package of goods ordered by each identified package recipient who ordered the package of goods from the shipper; and
selecting, by the package tracking platform from the identified package recipients, the package recipients who ordered the package of goods from the shipper, wherein the package has the package status of a SHIP or a RETURN.

3. The method of claim 2, wherein the package tracker is the package provider.

4. The method of claim 1, said method comprising:
generating, by the package tracking platform, the package tracking webpage for each selected package recipient.

5. The method of claim 4, wherein said generating the package tracking webpage for each selected package recipient comprises:
providing, by the package tracking platform, scripts for generating package tracking webpages; and
before said displaying the promotion, generating, by the package tracking platform, the package tracking webpage, using the scripts.

6. The method of claim 1, said method comprising:
providing, by the package tracking platform to each package recipient who is linked to the package tracking webpage, the package status and related details.

7. The method of claim 1, wherein the request limits said displaying the promotion to only package recipients whose package has the package status of the SHIP status.

8. The method of claim 1, wherein the request limits said displaying to only package recipients whose package has the package status of the RETURN status.

9. The method of claim 1, wherein the package provider is the shipper.

10. The method of claim 1, wherein the package provider is one freight carrier.

11. The method of claim 1, wherein the package tracking website is owned or controlled by the package tracking platform.

12. The method of claim 1, said method comprising:
sending, by the package tracking platform, an electronic communication to one selected package recipient of the selected package recipients, wherein the electronic communication includes a link to the package tracking webpage, and wherein the electronic communication invites the one selected package recipient to activate the link to the package tracking webpage; and
performing said displaying the promotion to the one selected package in response to activation of the link to the package tracking webpage by the one selected package recipient.

13. The method of claim 1, wherein the package tracking website is not owned or controlled by the package tracking platform and is owned by another platform that permits the package tracking website to perform said displaying the promotion to each selected package recipient who is currently linked to the package tracking webpage.

14. The method of claim 1, said method comprising:
dynamically updating the recipient profile of each package recipient of the multiple package recipients whose recipient profile is modified by an addition of, a deletion of, or a change in one or more parameters in the recipient profile.

15. A computer program product, comprising one or more computer readable hardware storage devices having computer readable program code stored therein, said program code containing instructions executable by one or more processors of a package tracking platform to implement a method for displaying a promotion to package recipients linked to webpages, said method comprising:
receiving a request to display the promotion to package recipients selected from multiple package recipients having respective recipient profiles, wherein the request specifies recipient criteria to be satisfied;
selecting, or receiving a selection of, package recipients from multiple package recipients, said package recipients being selected, or having been selected, based on (i) the recipient profile of each selected package recipient satisfying the recipient criteria specified in the request and (ii) each selected package recipient having ordered a package of good from a shipper such that the package has the package status of a SHIP status of currently being shipped to the package recipient via a first freight carrier or a RETURN status of currently being returned from the package recipient to the shipper via a second freight carrier; and
displaying, on a package tracking webpage of a package tracking website, the promotion to each selected package recipient who is linked to the package tracking webpage, wherein the package tracking webpage has a look and feel of a webpage at a website of a package provider selected from the group consisting of the shipper and one freight carrier, wherein the one freight carrier is the first freight carrier or the second freight carrier if the package currently has the SHIP status or the RETURN status, respectively,
wherein the package tracking website is not owned or controlled by the package provider.

16. The computer program product of claim 15, wherein said selecting the package recipients comprises:
cross referencing the recipient profile of each package recipient of the multiple package recipients with the recipient criteria specified in the request to identify package recipients whose recipient profile satisfies the recipient criteria; and
receiving, from a package tracker, the package status and related details of a package of goods ordered by each identified package recipient who ordered the package of goods from the shipper; and
selecting, from the identified package recipients, the package recipients who ordered the package of goods from the shipper, wherein the package has the package status of a SHIP or a RETURN.

17. The computer program product of claim 15, said method comprising:
generating the package tracking webpage for each selected package recipient.

18. A package tracking platform, comprising, one or more processors, one or more memories, and one or more computer readable hardware storage devices, said one or more hardware storage devices containing program code executable by the one or more processors via the one or more memories to implement a method for displaying a promotion to package recipients linked to webpages, said method comprising:
receiving a request to display the promotion to package recipients selected from multiple package recipients having respective recipient profiles, wherein the request specifies recipient criteria to be satisfied;
selecting, or receiving a selection of, package recipients from multiple package recipients, said package recipients being selected, or having been selected, based on (i) the recipient profile of each selected package recipient satisfying the recipient criteria specified in the request and (ii) each selected package recipient having ordered a package of good from a shipper such that the package has the package status of a SHIP status of currently being shipped to the package recipient via a first freight carrier or a RETURN status of currently being returned from the package recipient to the shipper via a second freight carrier; and
displaying, on a package tracking webpage of a package tracking website, the promotion to each selected package recipient who is linked to the package tracking webpage, wherein the package tracking webpage has a look and feel of a webpage at a website of a package provider selected from the group consisting of the shipper and one freight carrier, wherein the one freight carrier is the first freight carrier or the second freight carrier if the package currently has the SHIP status or the RETURN status, respectively,
wherein the package tracking website is not owned or controlled by the package provider.

19. The package tracking platform of claim 18, wherein said selecting the package recipients comprises:
cross referencing the recipient profile of each package recipient of the multiple package recipients with the recipient criteria specified in the request to identify package recipients whose recipient profile satisfies the recipient criteria; and
receiving, from a package tracker, the package status and related details of a package of goods ordered by each identified package recipient who ordered the package of goods from the shipper; and
selecting, from the identified package recipients, the package recipients who ordered the package of goods from the shipper, wherein the package has the package status of a SHIP or a RETURN.

20. The package tracking platform of claim 18, said method comprising:
generating the package tracking webpage for each selected package recipient.
